(19) United States
(12) Patent Application Publication
(10) Pub. No.: US 2026/0252475 A1
(43) Pub. Date: Aug. 27, 2026

(54) AUTOMATED DETECTION OF FEATURES IN APPLICATIONS

(71) Applicant: Truist Bank, Charlotte, NC (US)

(72) Inventors: Kenneth William Cluff, Powhatan, VA (US); James A. Mackin, Naples, FL (US)

(73) Assignee: Truist Bank, Charlotte, NC (US)

(21) Appl. No.: 19/064,128

(22) Filed: Feb. 26, 2025

(51) Int. Cl. G06F 11/3668

(52) U.S. Cl. CPC G06F 11/3692

(57) ABSTRACT

Detecting application features within application portfolios. A processor may receive a request comprising an application. The processor may generate a first embedding vector based on the request. A model executed by the processor analyzes an embedding database that contains embedding vectors for multiple applications. Based on this analysis, the model identifies a first application within the plurality that features characteristics similar to those of the application in the request. Subsequently, the processor generates a report indicating that the first application includes these associated features and transmits the report to multiple recipients.

### BACKGROUND

Identifying artificial intelligence (AI) or other features within application portfolios presents significant challenges due to the diverse and evolving nature of technologies. Applications often integrate AI or other features in varied ways, ranging from simple automation scripts to complex machine learning models. This variability, coupled with non-standardized documentation and frequent updates, makes it difficult to accurately catalog software components.

### BRIEF SUMMARY

In various embodiments, a method involves a processor receiving a request that includes an application. The processor generates a first embedding vector based on the request. A model executing on the processor then uses this embedding vector to analyze an embedding database that contains embedding vectors associated with multiple applications. Through this analysis, the model identifies a first application among these applications that includes features related to the initial application. The processor subsequently generates a report indicating that the first application has these associated features and transmits this report to multiple recipients.

In other embodiments, a non-transitory computer-readable storage medium includes instructions that, when executed by a processor, perform the actions of receiving a request with an application, generating a first embedding vector, analyzing an embedding database, determining a relevant application, generating a report, and transmitting the report to various recipients.

Additionally, other embodiments involve an apparatus consisting of a processor and a memory. The memory stores instructions that, when the processor executes them, cause the processor to receive an application-inclusive request, generate a first embedding vector, analyze the embedding database with a model, identify a significant application, create a report about the application with related features, and send this report to multiple recipients.

The features, functions, and advantages that have been described herein may be achieved independently in various embodiments of the present disclosure including computer-implemented methods, computer program products, and computing systems or may be combined in yet other embodiments, further details of which can be seen with reference to the following description and drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5A illustrates an aspect of the subject matter in accordance with one embodiment.

FIG. 5B illustrates an aspect of the subject matter in accordance with one embodiment.

FIG. 6 illustrates a logic flow 600 in accordance with one embodiment.

FIG. 7 illustrates a logic flow 700 in accordance with one embodiment.

FIG. 8 illustrates a logic flow 800 in accordance with one embodiment.

FIG. 9A is a diagram of a feedforward network, according to at least one embodiment, utilized in machine learning.

FIG. 9B is a diagram of a convolutional neural network, according to at least one embodiment, utilized in machine learning.

FIG. 9C is a diagram of a portion of the convolutional neural network of FIG. 9B, according to at least one embodiment, illustrating assigned weights at connections or neurons.

FIG. 10 is a diagram representing an exemplary weighted sum computation in a node in an artificial neural network.

FIG. 11 is a diagram of a Recurrent Neural Network (RNN), according to at least one embodiment, utilized in machine learning.

FIG. 12 is a schematic logic diagram of an artificial intelligence program including a front-end and a back-end algorithm.

FIG. 13 is a flow chart representing a method, according to at least one embodiment, of model development and deployment by machine learning.

FIG. 14 illustrates a computing system 1400 in accordance with one embodiment.

### DETAILED DESCRIPTION

Embodiments disclosed herein include techniques for detecting the presence of specific features within applications. The features may include any type of feature that can be included in a software, such as generative artificial intelligence (AI) features, functionalities, libraries, etc. Therefore, the use of AI features as a reference example should not be considered limiting of the disclosure. Similarly, the software may be any type of software, such as applications, artificial intelligence agents, services, application programming interfaces (APIs), microservices, processes, etc. In some embodiments, the software may be provided according to any framework, such as Software as a Service (SaaS), Platform as a Service (PaaS), etc. Therefore, the use of applications in a SaaS framework should not be considered limiting of the disclosure.

In some embodiments, documents associated with software (e.g., release notes, documentation, advertisements, manuals, etc.) may be used to identify features. In some embodiments, the addition of a document to a database automatically initiates a workflow for identifying the presence of generative AI features. For example, the added documents may be pre-processed for text, data, and/or image extraction, followed by embedding generation to create vector representations of the extracted text, data, and/or images. The vectorized data may be stored in a vector database for efficient retrieval and analysis.

In some embodiments, one or more agents, which may include one or more models, may analyze the vectors to identify the presence of generative AI features in the software. For example, the models may analyze the vectors using pattern recognition, historical comparison, similarity, etc. When generative AI-related features are detected, alerts may be generated, classified, and formatted for presentation. The alerts may be stored in an alert queue. Furthermore, a dashboard for reviewing the alerts may be provided, which may incorporate user feedback to improve detection accuracy.

In some embodiments, a custom embedding model is used to generate embeddings based on multimodal data, including text, diagrams, and tables. Doing so may ensure comprehensive data representation and facilitate accurate pattern recognition. Furthermore, ranking models may be used to prioritize alerts based on their relevance and severity. In some embodiments, the ranking models may compute a probability score indicating the likelihood of AI presence. In some embodiments, a feedback loop is used to continuously improve the accuracy of the detection process, e.g., by retraining models, providing additional grounding, adding samples to training data, adjusting model parameters, modifying weights of the models, etc.

By processing documents associated with software as they are released, embodiments disclosed herein may leverage a time series of releases. Stated differently, by monitoring software as it evolves over time, embodiments disclosed herein may identify changes to the software. For example, documents associated with a plurality of prior version of software may be analyzed to create a timeline of the software. When a document associated with a new version of the software is released, embodiments disclosed herein may leverage the time series to identify features that are added, modified, and/or removed from the software.

In some embodiments, a governance framework is implemented to review and validate the detection process. The framework may ensure adherence to internal policies, laws, regulatory requirements, etc., providing transparency and accountability. For example, if internal policies restrict the use of generative AI features in payment processing applications, the framework may ensure that any payment processing applications that introduce generative AI features are identified and disabled or otherwise restricted from use.

In some embodiments, an AI agent (e.g., a chatbot) may interact with the users to provide insights into the organization's application portfolios. For example, a user may ask the chatbot natural language questions, such as which applications include generative AI features, which applications are similar to an input application (e.g., which applications provide similar features to the input feature), which applications implement specific libraries, which applications include a specific feature, etc. Doing so may identify applications prone to specific risks or dependencies, helping the organization manage its application portfolio more effectively.

Similarly, reports may be generated for relevant stakeholders, e.g., reports on which applications include generative AI features, reports of applications that include specific features, reports on the inputs and/or outputs of generative AI features, reports on how data is processed, etc. More generally, as new features are identified, users may be notified of the presence of the new features in the application portfolio. The disclosed comprehensive framework ensures robust and reliable detection and management of generative AI in SaaS applications.

Advantageously, embodiments disclosed herein ensure that any application features, such as generative AI features, are effectively detected, assessed, and managed, reducing the likelihood of unintentional integration of features in the application portfolio. Automating the detection process may reduce human error and oversight, ensuring consistent identification and reporting of specific application features. By automating the process of detecting application features, the system reduces the need for manual review and oversight. This increases efficiency and allows for the processing of large volumes of data quickly and accurately. Furthermore, by leveraging documentation and embedding vectors, embodiments disclosed herein identify the presence of features in application portfolios more accurately relative to conventional solutions. For example, by analyzing embedding vectors and comparing them with historical data, embodiments disclosed herein may detect subtle patterns that may indicate the presence of application features. Doing so improves the accuracy of computing systems used to detect application features. Embodiments are not limited in these contexts.

Aspects of the present disclosure and certain features, advantages, and details thereof are explained more fully below with reference to the non-limiting examples illustrated in the accompanying drawings. Descriptions of well-known processing techniques, systems, components, etc. are omitted so as to not unnecessarily obscure the disclosure in detail. It should be understood that the detailed description and the specific examples, while indicating aspects of the disclosure, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments. Like numbers refer to like elements throughout.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the disclosure. Therefore, it is to be understood that, within the scope of the included claims, the disclosure may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present disclosure can include fixed function hardware, while other embodiments can utilize a software-based implementation of the functionality described. Certain embodiments combine both types of program code.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

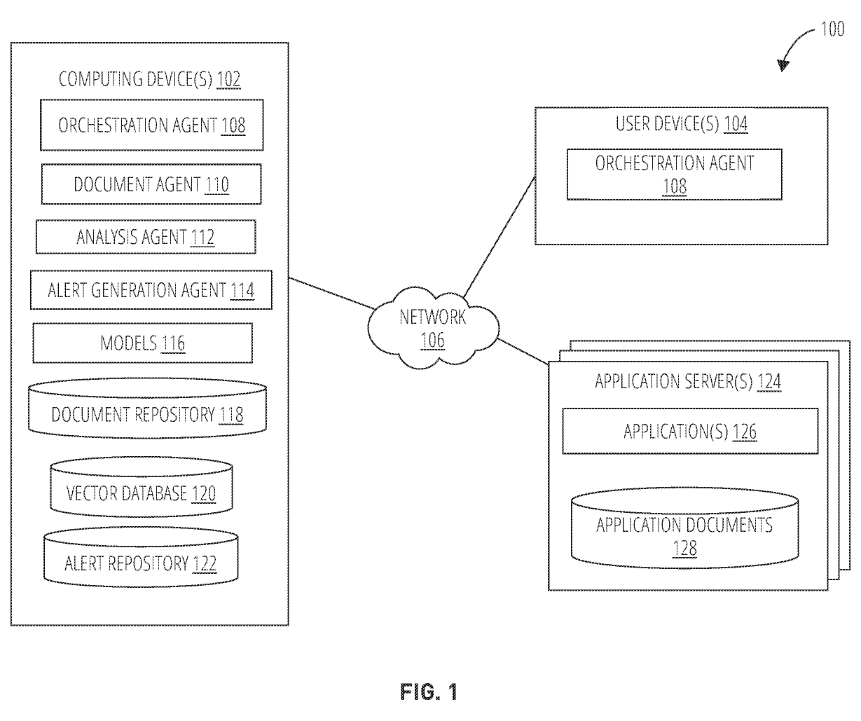

FIG. 1 illustrates a system 100 according to one embodiment. As shown, the system 100 includes one or more computing devices 102, one or more user devices 104, and one or more application servers 124 communicably coupled via one or more networks 106. The computing devices 102, user devices 104, and application servers 124 are representative of any type of physical and/or virtualized computing system. The computing devices 102, user devices 104, and application servers 124 each include at least one processor for executing instructions and at least one memory for storing instructions, each not pictured for the sake of clarity.

As shown, the application servers 124 store, host, provide, or otherwise execute one or more applications 126. Although depicted as applications, the disclosure is equally applicable to other types of executable code, such as microservices, processes, scripts, AI agents, services, application programming interfaces (APIs), etc. The applications 126 are representative of any number and type of applications, such as such as enterprise resource planning (ERP) applications, productivity applications, games, mobile applications, video conferencing applications, audio conferencing applications, voice over internet protocol (VoIP) applications, soft phone applications, messaging applications, chatbots, email clients, web browsers, document editors, account management applications, mobile P2P payment system client applications, financial applications, payment applications, network functions, Automated Clearing House (ACH) applications, FedNow payment applications, real-time payments (RTP) applications, monetary transfer applications, mobile wallet applications, accounting applications, payment processing frameworks, etc.

In some embodiments, the system 100 is associated with an entity such as a financial institution, business, government institution, educational institution, etc. Therefore, one or more of the applications 126 may be developed by external entities, e.g., third-party software providers. Some of the applications 126 may be developed internally. Over time, the software developers may update the applications 126, e.g., to correct errors, introduce new features, remove existing features, etc. These updates and other information may be reflected in one or more application documents 128 and/or document repository 118. The document repository 118 and/or application documents 128 therefore include release notes, frequently asked question (FAQ) documents, software documentation, marketing documents, technical notes, advertisements, user manuals, or any other type of document associated with the applications 126. For example, a first application 126 may have one or more documents in the application documents 128, such as user manuals, documentation, release notes, etc.

When a document is added to the application documents 128 and/or document repository 118, a trigger may be executed to initiate a workflow to detect features in the applications 126. The features may include any type of feature, such as generative AI features, chatbots, payment features, libraries, known security vulnerabilities, functionalities, etc. As stated above, the use of generative AI features as an example feature herein should not be considered limiting of the disclosure.

In some embodiments, the workflow is orchestrated by the orchestration agent 108 of the computing devices 102 and/or the user devices 104. The orchestration agent 108 may initiate the workflow based on receiving a trigger from the application documents 128, at periodic time intervals, and/or based on user input. Generally, the orchestration agent 108, which may include the document agent 110, analysis agent 112, and alert generation agent 114, may analyze the newly added (and/or previously existing) application documents 128 to detect the presence of generative AI features in an application 126. For example, the orchestration agent 108, document agent 110, analysis agent 112, and alert generation agent 114 may each include one or more models 116 to detect the presence of generative AI features in the applications 126. The models 116 may be implemented as any type of AI model, such as machine learning (ML) models, neural networks, large language models (LLMs), etc. Therefore, in some embodiments, the orchestration agent 108, document agent 110, analysis agent 112, and alert generation agent 114 are AI agents that include LLMs, where the AI agents include natural language processing capabilities. The orchestration agent 108, document agent 110, analysis agent 112, and alert generation agent 114 each include one or more of the models 116.

An AI agent is an autonomous system designed to perform tasks, make decisions, and adapt based on data and user feedback. An AI agent operates independently, automating processes in various fields, including the ability to generate code, communicate using natural language, etc. AI agents may operate without human intervention, making decisions and taking actions based on their programming and learning. AI agents may use machine learning algorithms to improve their performance over time by learning from data and experiences. Similarly, AI agents can perceive their environment through sensors or data inputs, allowing them to understand and interact with the world around them. Further still, AI agents may process information and make decisions based on logical reasoning, often using techniques like rule-based systems, neural networks, or probabilistic models. AI agents may communicate with humans and other systems through natural language processing, speech recognition, and other interfaces. AI agents may be designed to achieve specific goals or complete tasks, often optimizing their actions to maximize efficiency or effectiveness. Advantageously, AI agents may be scaled to handle large amounts of data and complex tasks, making them suitable for a wide range of applications.

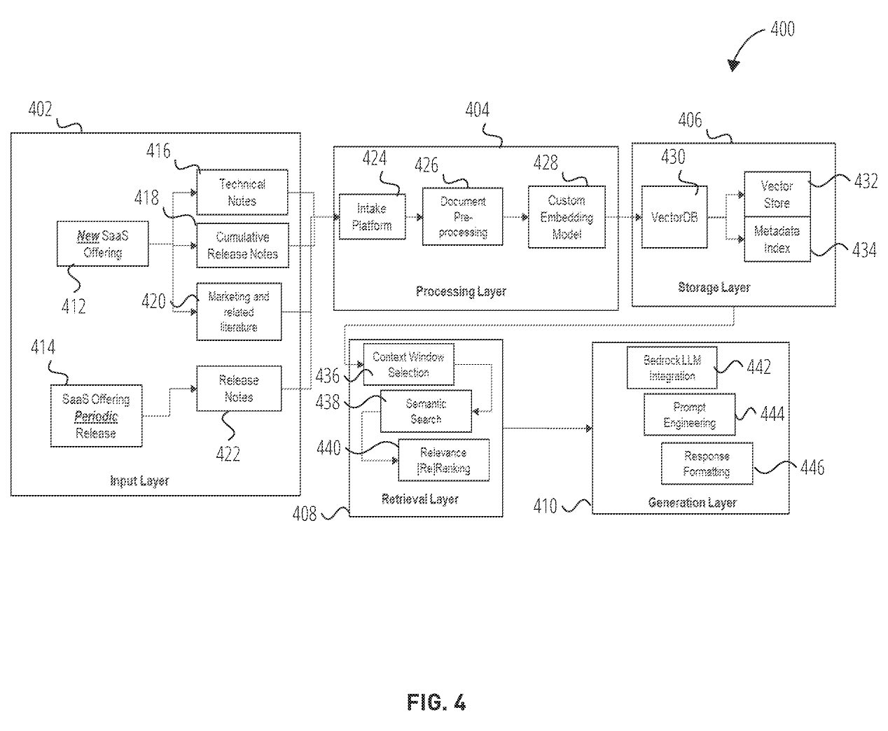

Although depicted as AI agents, the orchestration agent 108, document agent 110, analysis agent 112, and alert generation agent 114 may be implemented as other types of software. For example, the functionality of the orchestration agent 108, document agent 110, analysis agent 112, and alert generation agent 114 may be implemented as services in one or more layers, such as depicted in FIG. 4.

The orchestration agent 108, document agent 110, analysis agent 112, and alert generation agent 114 may be programmed to include a governance framework. The framework may include internal policies, laws, regulatory requirements, etc., providing transparency and accountability. For example, if internal policies restrict the use of generative AI features in payment processing applications, the orchestration agent 108, document agent 110, analysis agent 112, and alert generation agent 114 may collectively ensure that any payment processing applications that introduce generative AI features are identified and disabled or otherwise restricted from use.

In some embodiments, the orchestration agent 108, document agent 110, analysis agent 112, and alert generation agent 114 may leverage one or more prompt templates. For example, the prompt templates may include guardrails according to the governance framework (e.g., permitted features, restricted features, etc.). The prompt templates may further instruct the orchestration agent 108, document agent 110, analysis agent 112, and alert generation agent 114 (and/or their underlying models 116) how to operate, e.g., such indicating that they can ingest documents, vectorize the documents, store the vectors in vector database 120, and analyze the vectors in the vector database 120 to identify the presence of specific application features in the application 126. In embodiments where the orchestration agent 108 initiates the workflow based on user input, the prompt templates may include information associated with the user input. For example, if the user input specifies to “search for applications that include payment features”, the prompt template may be generated to identify applications 126 that include payment features. Embodiments are not limited in these contexts.

For example, based on receiving release notes for an application 126 from the application documents 128, the orchestration agent 108 may cause the document agent 110 to analyze the release notes, e.g., to extract images, text, and/or other data from the release notes. In some embodiments, when a document from the application documents 128 is received, the orchestration agent 108 may store the document in the document repository 118. In some embodiments, the document agent 110 may include one or more models 116 to process the document from the application documents 128, such as a multimodal model to convert images to text, convert data (e.g., database tables, charts, graphs, etc.) to a standardized format such as text, etc. The multimodal models 116 may further compute one or more embeddings based on the extracted data, such that the extracted data is represented in vector form. An embedding vector may be a vector of floating point numbers, where each entry of the vector corresponds to a feature or set of features. The computed vectors may be stored in the vector database 120 with an indication of the associated document from the document repository 118 and/or application documents 128, the associated application 126, and any associated metadata (e.g., a date of the software release, etc.).

The orchestration agent 108 may then cause the analysis agent 112 to analyze the embeddings generated based on the document. For example, the analysis agent 112 may use one or more models 116 to identify embeddings in the vector database 120 that are similar to the embeddings generated based on the document. The similarity may be based on any suitable technique, such as classifying the embeddings, clustering the embeddings, comparing the embeddings (e.g., using cosine similarity and/or Euclidean distances), pattern recognition, etc.

For example, when searching for generative AI features, the analysis agent 112 and/or the models 116 of the analysis agent 112 may classify the embeddings and/or extracted features from the documents into categories such as “AI-related,” “non-AI-related,” or other relevant classifications. Similarly, clustering embeddings causes similar embeddings to be grouped together. Therefore, if the embeddings are clustered into a cluster of embeddings that are associated with generative AI, the analysis agent 112 may detect the presence of generative AI features. Similarly, by computing the cosine similarity of two embeddings, the analysis agent 112 may determine the similarity of the embeddings. In some embodiments, the analysis agent 112 may apply a cosine similarity threshold to the cosine similarity, e.g., a threshold of 0.5 may be applied, such that cosine similarity values greater than (or equal to) the threshold may be considered similar. As another example, by computing the Euclidean distance of two embeddings, the analysis agent 112 may determine the similarity of the embeddings. In some embodiments, the analysis agent 112 may apply a Euclidean distance threshold to the Euclidean distance, e.g., a threshold of 0.5 may be applied, such that Euclidean distance values greater than (or equal to) the threshold may be considered similar. Therefore, in some embodiments, the similarity of vectors may reflect the similarity of features and/or applications.

In some embodiments, the analysis agent 112 may compare the vectors for the current version of a release note document for an application 126 to the vectors of all of the cumulative release notes for the application 126 in the vector database 120. In some embodiments, the analysis agent 112 may perform a risk analysis to determine a relative risk of any identified application features. For example, the risk assessment may include the analysis agent 112 computing a risk score, classifying the risk into one or more risk levels of a plurality of risk levels (e.g., low, medium, high, etc.) using one or more of the models 116 (such as ranking models, etc.). In some embodiments, the vector analysis, pattern recognition, historical analysis, and/or risk assessment may be used to compute an alert score for any identified application features in the document. For example, the alert score may be a floating point value on a range from 0 to 1. In some embodiments, the analysis agent 112 may compare the alert score to an alert threshold. For example, if the alert threshold is .4, and the alert score for a detected generative AI feature is .3, an alert may not be generated for the generative AI feature. Similarly, if the alert score is .7, exceeding the threshold, an alert may be generated for the detected generative AI feature. However, in some embodiments, an alert is generated for any detected feature.

In some embodiments, the alert generation agent 114 may use one or more of the models 116 to classify the alert. In some embodiments, the alert generation agent 114 may use one or more models 116 to assign a priority value to the alert. The alert generation agent 114 may further use one or more models 116 to format the alert based on a predetermined alert format. For example, the alert format may include assigning a unique identifier to the alert, associating the alert with the application 126 and/or document from the document repository 118 and/or application documents 128, and one or more links to specific locations where support for the identified feature can be found. For example, if page 4, paragraph 1 of the release notes discuss generative AI features, a link to paragraph 1, page, 4 of the release notes may be included in the alert. Doing so allows the link to be selected by a reviewing user to confirm the presence of the generative AI features.

The orchestration agent 108 may then store the generated alert in the alert repository 122, e.g., an alert queue. Doing so allows a user to access and review the alerts in the alert repository 122. For example, if an alert indicates an application 126 includes generative AI features, the user may review the documentation and determine whether any corrective actions need to be taken. For example, if the generative AI features violate policies against using generative AI, the user may restrict use of the generative AI features in the application 126. As another example, the user may restrict the use of the application 126 entirely. Embodiments are not limited in these contexts, as any number and types of actions may be initiated responsive to reviewing the alerts in the alert repository 122.

The user review may be used to refine the orchestration agent 108, document agent 110, analysis agent 112, alert generation agent 114, and/or the models 116. For example, the user may generally provide feedback confirming the presence of generative AI features identified based on the processing by the orchestration agent 108, document agent 110, analysis agent 112, alert generation agent 114, and/or the models 116. As another example, the user may indicate the AI features are not present, and the AI features were incorrectly identified. This feedback and/or the generated output may be used to retrain the orchestration agent 108, document agent 110, analysis agent 112, alert generation agent 114, and/or the models 116. As another example, the feedback and/or the generated output may be used to provide additional grounding, add samples to training data, adjust parameters of the orchestration agent 108, document agent 110, analysis agent 112, alert generation agent 114, and/or the models 116, modifying weights of the orchestration agent 108, document agent 110, analysis agent 112, alert generation agent 114, and/or the models 116, etc.

Advantageously, the document processing, feature extraction, and embedding vector generation provide a framework for any number and type of additional features. For example, the orchestration agent 108 may use the vector database 120 to identify a particular application feature, generate reports of applications including the application feature, notify users of the availability of the application feature, identifying applications that have features similar to an input application, etc.

For example, a user may provide a natural language prompt to an AI chatbot provided by the orchestration agent 108 such as “identify applications that use log4j,” which is software associated with a known security vulnerability. The orchestration agent 108 may generate a prompt based on the user request. The document agent 110 may then generate one or more embeddings based on the user request and/or the prompt, and search the vector database 120 for similar embeddings, thereby identifying one or more applications 126 that include log4j. The identified applications 126 may be returned to the user by the orchestration agent 108, e.g., as a natural language response, report, list, etc. In some embodiments, an alert may be generated for the identified applications 126 and stored in the alert repository 122. Doing so may allow users to correct the security vulnerability of the applications 126 that use log4j, disable the applications 126, etc.

As another example, a user may provide a natural language prompt to the orchestration agent 108 such as “identify applications that provide accounting features like application XYZ,” where application XYZ is an example accounting application. The orchestration agent 108 may generate a prompt based on the user request. The document agent 110 may then generate one or more embeddings based on the user request and/or the prompt, and search the vector database 120 for similar embeddings, thereby identifying one or more applications 126 that include accounting features. The identified applications 126 may be returned to the user by the orchestration agent 108, e.g., as a natural language response, report, list, etc.

Similarly, the orchestration agent 108 may generate reports to describe the inputs and/or outputs of applications 126 (e.g., generative AI features), reports on how data is processed by applications 126, etc. More generally, as new features are identified in applications 126, the orchestration agent 108 may users notify of the presence of the new features in the application portfolio. Embodiments are not limited in these contexts.

In one embodiment, when a user decides to enroll in a mobile banking program, the user downloads or otherwise obtains the mobile banking system client application from a mobile banking system, for example enterprise system 100, or from a distinct application server. In other embodiments, the user interacts with a mobile banking system via a web browser application in addition to, or instead of, the mobile P2P payment system client application.

The network 106 may also incorporate various cloud-based deployment models including private cloud (e.g., an organization-based cloud managed by either the organization or third parties and hosted on-premises or off premises), public cloud (e.g., cloud-based infrastructure available to the general public that is owned by an organization that sells cloud services), community cloud (e.g., cloud-based infrastructure shared by several organizations and manages by the organizations or third parties and hosted on-premises or off premises), and/or hybrid cloud (e.g., composed of two or more clouds e.g., private community, and/or public).

The user devices 104 may include automatic teller machines (ATMs) utilized by the system 100 in serving users. In another example, the computing devices 102 represent payment clearinghouse or payment rail systems for processing payment transactions, and in another example, the computing devices 102 such as merchant systems or banking systems configured to interact with the user devices 104 during transactions and also configured to interact with the enterprise system 100 in back-end transactions clearing processes.

The user devices 104 may also be configured to obtain and process various forms of authentication via an authentication system to obtain authentication information of a user. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user’s eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

System 100 as illustrated diagrammatically represents at least one example of a possible implementation, where alternatives, additions, and modifications are possible for performing some or all of the described methods, operations, and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The system 100 can offer any number or type of services and products to one or more users. In some examples, an enterprise system 100 offers products. In some examples, an enterprise system 100 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 100, automated assistance may be provided by the enterprise system 100. For example, automated access to user accounts and replies to inquiries may be provided by enterprise-side automated voice, text, and graphical display communications and interactions. In at least some examples, any number of human agents, can be employed, utilized, authorized, or referred by the enterprise system 100. Such human agents can be, as non-limiting examples, point of sale or point of service (POS) representatives, online customer service assistants available to users, advisors, managers, sales team members, and referral agents ready to route user requests and communications to preferred or particular other agents, human or virtual.

Human agents may utilize agent devices (e.g., user devices 104) to serve users in their interactions to communicate and take action. In such embodiments, the user devices 104 can be, as non-limiting examples, computing devices, kiosks, terminals, smart devices such as phones, and devices and tools at customer service counters and windows at POS locations.

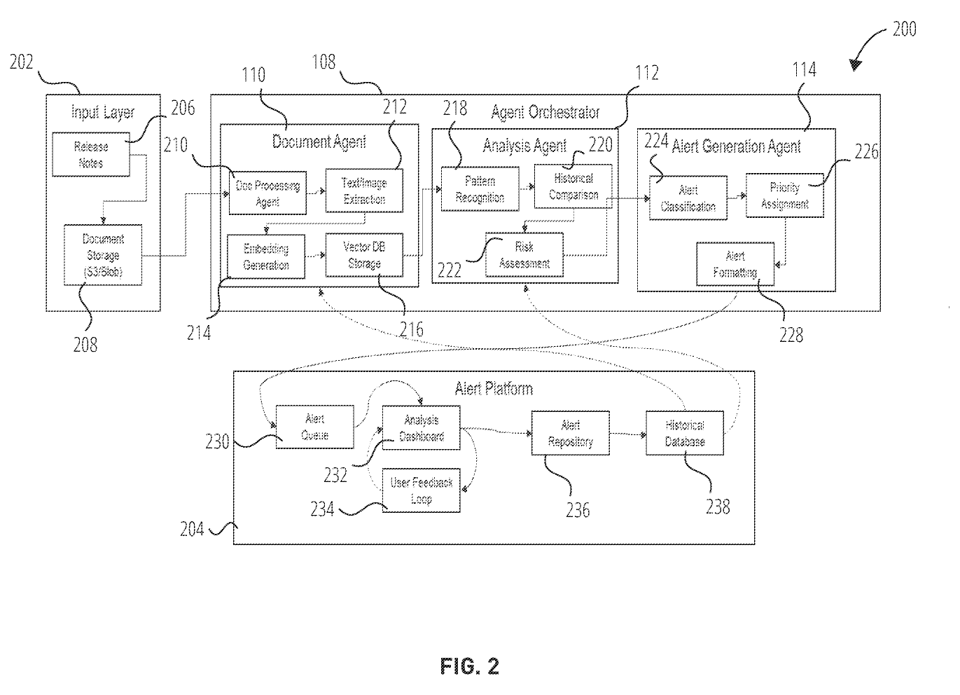

FIG. 2 illustrates a schematic 200 to detect features such as generative artificial intelligence in application portfolios, according to one embodiment.

As shown, an input layer 202 may include a block 206, where release notes or other documents associated with software are received. The software may include applications currently being used in a computing environment and/or software being considered for use in the computing environment. For example, a developer of an application 126 may provide release notes, documentation, etc., as one or more of the application documents 128. The application documents 128 may be accessed by the orchestration agent 108 and stored at block 208, e.g., in the document repository 118. The storage of the documents in the application documents 128 and/or the document repository 118 may initiate a workflow orchestrated by the orchestration agent 108.

For example, at block 210, the document agent 110 may access or otherwise receive the document stored in the document repository 118 at block 208. In some embodiments, the document agent 110 may preprocess the document, e.g., using one or more models 116. At block 212, the document agent 110 causes one or more models 116 to extract text, images, and/or other data from the document. At block 214, the document agent 110 causes a multimodal embedding model, e.g., one of the models 116, to generate embeddings on the data extracted at block 212. At block 214, the document agent 110 stores the embedding vectors generated at block 212 in the vector database 120.

At block 216, the analysis agent 112 may access or otherwise receive the embeddings generated at block 214 and perform pattern recognition, e.g., using one or more models 116 and based on other vectors in the vector database 120. Generally, the pattern recognition may include identifying similar vectors in the vector database 120. At block 220, the analysis agent 112 may perform a historical comparison based on other versions of the software being analyzed. For example, the historical comparison may include one or more models 116 analyzing the current vector and vectors in the vector database 120 associated with older versions of the software. At block 222, the analysis agent 112 may perform a risk assessment of any features identified at blocks 218 or 220, e.g., generative AI features. In some embodiments, the risk assessment includes computing one or more scores for the identified features. In some embodiments, the scores may be compared to one or more thresholds.

At block 224, the alert generation agent 114 may receive the output of the analysis agent 112, e.g., one or more scores, an indication of an identified feature, an indication of an alert, etc. The alert generation agent 114 may cause a model 116 to classify the alert. At block 226, the alert generation agent 114 may cause a model 116 to assign a priority level and/or value to the alert. At block 228, the alert generation agent 114 may cause a model 116 to format the alert according to a predetermined format. The alert may be stored in an alert queue at block 230, where the alert queue may be the alert repository 122.

As shown an alert platform 204 may include blocks 220-238. In some embodiments, the alert platform 204 is part of the orchestration agent 108. At block 232, a user may access an analysis dashboard, e.g., a graphical user interface provided by the orchestration agent 108 that displays alerts from the alert repository 122. Generally, a user interacting with the alerts may perform any number and type of actions, such as feedback confirming the presence of an identified feature, feedback indicating the identified feature is not present in the software, etc. At block 234, a feedback loop may be performed based on the user feedback. For example, the orchestration agent 108, document agent 110, analysis agent 112, alert generation agent 114, and/or the models 116 may be retrained based on the feedback. As another example, the feedback may be used to provide additional grounding, add samples to training data used to train the orchestration agent 108, document agent 110, analysis agent 112, alert generation agent 114, and/or the models 116, adjust parameters of the models 116, modify weights of the orchestration agent 108, document agent 110, analysis agent 112, alert generation agent 114, and/or the models 116, etc.

At block 236, the user feedback may be stored with the alert in the alert repository 122. At block 238, the alert repository 122, acting as a historical database, may be used to improve the accuracy of the orchestration agent 108, document agent 110, analysis agent 112, alert generation agent 114, and/or the models 116. For example, as stated, the identified features, user feedback, and any other data may be used to retrain the orchestration agent 108, document agent 110, analysis agent 112, alert generation agent 114, and/or the models 116. Similarly, the identified features, user feedback, and any other data may be used to provide additional grounding, add samples to training data used to train the orchestration agent 108, document agent 110, analysis agent 112, alert generation agent 114, and/or the models 116, adjust parameters of the orchestration agent 108, document agent 110, analysis agent 112, alert generation agent 114, and/or the models 116, modify weights of the orchestration agent 108, document agent 110, analysis agent 112, alert generation agent 114, and/or the models 116, etc. Embodiments are not limited in these contexts.

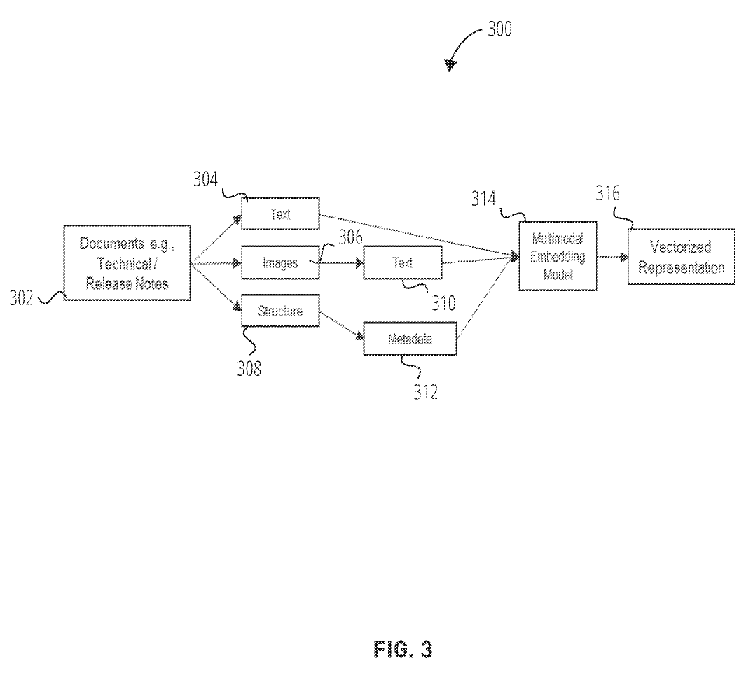

FIG. 3 illustrates a logic flow 300 for generating embedding vectors, according to one embodiment. As shown, at block 302, one or more documents associated with software may be received by the document agent 110. At block 304, the document agent 110 may extract from the documents. At block 306, the document agent 110 may extract images from the documents and convert the images to text at block 310. At block 308, the document agent 110 may extract structure from the documents and use the structure to generate metadata for the documents at block 312. At block 314, a multimodal embedding model 116 of the document agent 110 may compute embeddings for the text, images, structure, and/or metadata. At block 316, the document agent 110 may store the embeddings in the vector database 120. Embodiments are not limited in these contexts.

FIG. 4 illustrates a schematic 400 to detect features such as generative artificial intelligence in application portfolios, according to one embodiment.

As shown, an input layer 402 may include block 412, where documents associated with software applications are received. The documents may include technical notes 416, cumulative release notes 418, marketing and related literature 420, or any other type of document. The documents at block 412 may be associated with a new application. The new application may be an application 126 that is currently used by an entity and/or an application being considered for use by the entity. Similarly, at block 414, documents associated with a new version (e.g., a periodic release) of software may be received. The documents may include release notes 422, but may include other types of documents, such as technical notes 416, marketing and related literature 420, or any other type of document associated with the software.

As shown, a processing layer 404 may receive the input from the input layer 402. The processing layer 404 may include the document agent 110 and/or functionality similar to the document agent 110. At block 424, the documents may be received from the input layer 402. At block 426, the document agent 110 may preprocess the documents, e.g., using one or more models 116. The preprocessing may include some or all of the steps of the logic flow 300, e.g., text extraction, image extraction, data extraction, metadata extraction, image conversions, etc. At block 428 the document agent 110 causes a multimodal embedding model, e.g., one of the models 116, to generate embeddings on the data extracted at received from block 426.

At block 430, which may be part of a storage layer 406, the embeddings vectors generated at block 212 are stored in the vector database 120 by the orchestration agent 108 and/or the document agent 110. As shown, the vector database 120 may include a vector store 432 for storing embedding vectors and a metadata index 434 for storing metadata associated with the vectors (e.g., an associated application 126, document from the document repository 118, version, date, etc.).

At block 436, which may be part of a retrieval layer 408 including the analysis agent 112 and/or functionality similar to the analysis agent 112, a context selection window may be determined. At block 438, the analysis agent 112 may perform a semantic search on the vector database 120 using the determined context window and data received from the vector database 120. At block 440, relevance ranking and/or re-ranking may be performed using one or more models 116.

At block 442, which may be part of a generation layer 410 including the alert generation agent 114 and/or functionality similar to the alert generation agent 114, bedrock large language model (LLM) integration may be performed. At block 444, prompt engineering may be performed, e.g., to generate one or more prompt templates for use by the models 116. At block 446, the alert generation agent 114 may perform response formatting to format responses, e.g., in natural language. Embodiments are not limited in these contexts.

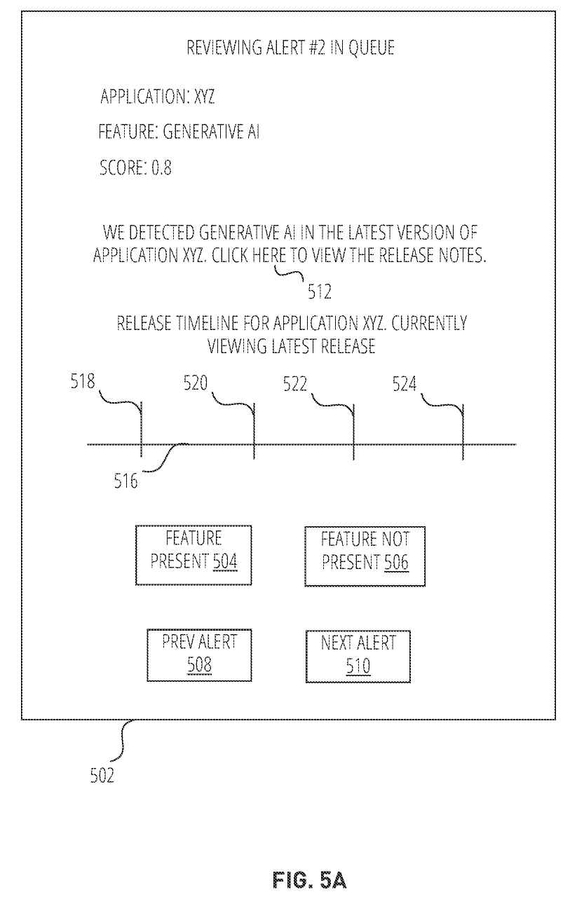

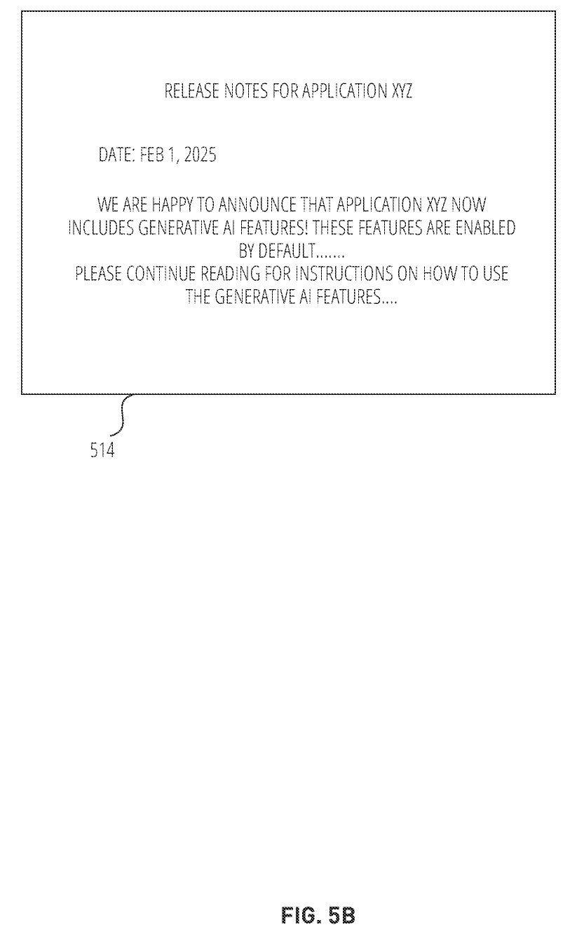

FIG. 5A depicts a graphical user interface 502, according to one embodiment. The graphical user interface 502 may be provided by the orchestration agent 108, e.g., via the alert platform 204.

As shown, the graphical user interface 502 reflects that a user is viewing an alert from the alert repository 122. The alert is associated with an example application 126, namely “application XYZ”, which was determined to include generative AI features according to the techniques described herein. As shown, the alert indicates a risk score of 0.8, e.g., on a scale from 0-1. The graphical user interface 502 further includes a link 512, which, when selected, causes the relevant portions of the release notes to be displayed to the user as depicted in FIG. 5B.

Furthermore, as shown, the graphical user interface 502 includes a timeline 516, reflecting different releases 518, 520, 522, and 524 of the application XYZ. The releases 518-524 may generally reflect a timeline of the releases of the application XYZ and corresponding application documents 128, where documentation associated with each release was previously analyzed to generate embeddings stored in the vector database 120.

As stated, a user may review the alerts from the alert repository 122 and provide feedback reflecting whether the identified feature is in fact present in the software. For example, by selecting selectable element 504, the user may confirm the presence of the generative AI feature in application XYZ. Similarly, by selecting selectable element 506, the user may indicate that the generative AI feature is not present in the application XYZ. As stated, the user's feedback may be used to retrain the models 116, provide grounding truths, etc. The user may cycle through other alerts in the alert repository 122 using selectable element 508 or selectable element 510. Embodiments are not limited in these contexts.

FIG. 5A illustrates a graphical user interface 514 depicting a portion of release notes of the application XYZ, according to one embodiment. The graphical user interface 514 may be generated by the orchestration agent 108 based on the selection of the link 512 of FIG. 5A. Generally, the link 512 may be directed to a storage location of the release notes in the document repository 118. More specifically, the link 512 may further be directed to specific portions of the document, e.g., the portions related to generative AI. Embodiments are not limited in these contexts.

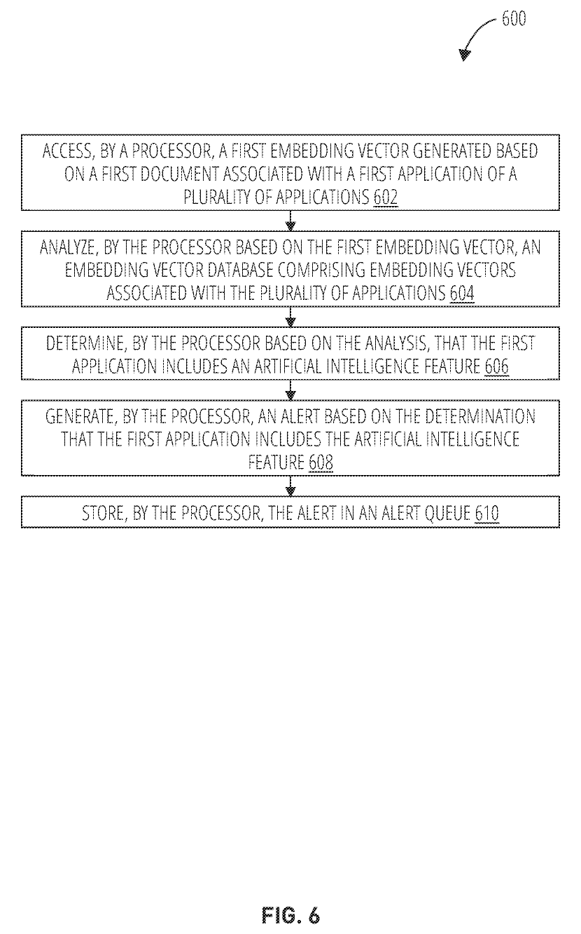

FIG. 6 illustrates an example logic flow 600 for detecting features such as generative artificial intelligence in application portfolios. Although the example logic flow 600 depicts a particular sequence of operations, the sequence may be altered without departing from the scope of the present disclosure. For example, some of the operations depicted may be performed in parallel or in a different sequence that does not materially affect the function of the logic flow 600. In other examples, different components of an example device or system that implements the logic flow 600 may perform functions at substantially the same time or in a specific sequence.

According to some examples, the logic flow 600 includes accessing, by a processor, a first embedding vector generated based on a first document associated with a first application of a plurality of applications at block 602. For example, the orchestration agent 108 illustrated in FIG. 1 may access a first embedding vector in the vector database 120 generated based on a first document associated with a first application 126 of a plurality of applications.

According to some examples, the logic flow 600 includes analyzing, by the processor based on the first embedding vector, an embedding vector database comprising embedding vectors associated with the plurality of applications at block 604. For example, the analysis agent 112 and/or models 116 illustrated in FIG. 1 may analyze, based on the first embedding vector, the embedding vector database 120 comprising embedding vectors associated with the plurality of applications.

According to some examples, the logic flow 600 includes determining, by the processor based on the analysis, that the first application includes an artificial intelligence feature at block 606. For example, the analysis agent 112 and/or models 116 may determine, based on the analysis, that the first application includes an artificial intelligence feature.

According to some examples, the logic flow 600 includes generating, by the processor, an alert based on the determination that the first application includes the artificial intelligence feature at block 608. For example, the alert generation agent 114 and/or models 116 illustrated in FIG. 1 may generate an alert based on the determination that the first application includes the artificial intelligence feature.

According to some examples, the logic flow 600 includes storing, by the processor, the alert in an alert queue at block 610. For example, the alert generation agent 114 may store the alert in an alert queue such as alert repository 122. Embodiments are not limited in these contexts.

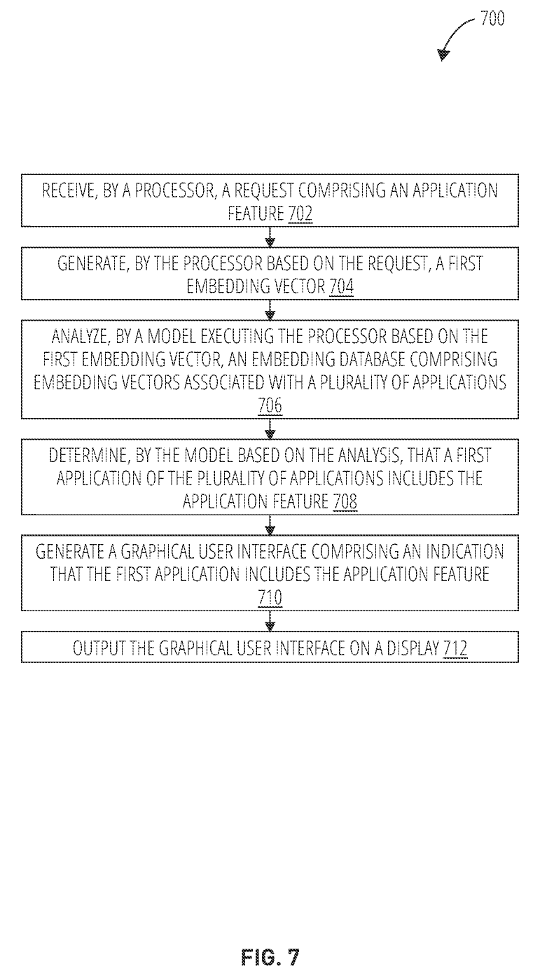

FIG. 7 illustrates an example logic flow 700 for detect features in application portfolios. Although the example logic flow 700 depicts a particular sequence of operations, the sequence may be altered without departing from the scope of the present disclosure. For example, some of the operations depicted may be performed in parallel or in a different sequence that does not materially affect the function of the logic flow 700. In other examples, different components of an example device or system that implements the logic flow 700 may perform functions at substantially the same time or in a specific sequence.

According to some examples, the logic flow 700 includes receiving, by a processor, a request comprising an application feature at block 702. For example, the orchestration agent 108 illustrated in FIG. 1 may receive, by a processor, a request comprising an application feature. For example, a user may write a message to a chatbot (e.g., the orchestration agent 108) specifying “find applications that send unencrypted data via the network.”

According to some examples, the logic flow 700 includes generating, by the processor based on the request, a first embedding vector at block 704. For example, the orchestration agent 108, the document agent 110, and/or the models 116 may generate, based on the request, a first embedding vector. The first embedding vector may generally reflect various features of the request.

According to some examples, the logic flow 700 includes analyzing, by the model executing on the processor based on the first embedding vector, an embedding database comprising embedding vectors associated with a plurality of applications at block 706. For example, the analysis agent 112 and/or the models 116 may analyze the vector database 120 based on the first embedding vector, e.g., to identify similar embedding vectors in the vector database 120.

According to some examples, the logic flow 700 includes determining, by the model based on the analysis, that a first application of the plurality of applications includes the application feature at block 708. For example, the analysis agent 112 and/or the models 116 may determine, based on the analysis, that a first application 126 of the plurality of applications 126 includes the application feature. For example, the first application 126 may transmit unencrypted data via a network.

According to some examples, the logic flow 700 includes generating a graphical user interface comprising an indication that the first application includes the application feature at block 710. For example, the orchestration agent 108 illustrated in FIG. 1 may generate a graphical user interface comprising an indication that the first application includes the application feature.

According to some examples, the logic flow 700 includes outputting the graphical user interface on a display at block 712. For example, the orchestration agent 108 may output the graphical user interface on a display. Embodiments are not limited in these contexts.

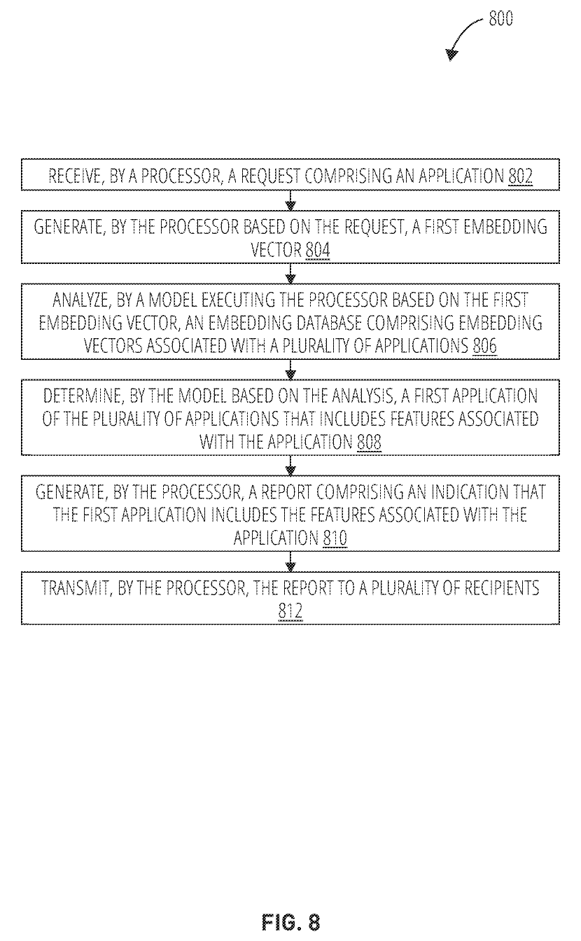

FIG. 8 illustrates an example logic flow 800 for identifying features in application portfolios. Although the example logic flow 800 depicts a particular sequence of operations, the sequence may be altered without departing from the scope of the present disclosure. For example, some of the operations depicted may be performed in parallel or in a different sequence that does not materially affect the function of the logic flow 800. In other examples, different components of an example device or system that implements the logic flow 800 may perform functions at substantially the same time or in a specific sequence.

According to some examples, the logic flow 800 includes receiving, by a processor, a request comprising an application at block 802. For example, the orchestration agent 108 illustrated in FIG. 1 may receive a request comprising an application. For example, a user may specify “what applications do we have that are similar to Acme statistical analysis program.”

According to some examples, the logic flow 800 includes generating, by the processor based on the request, a first embedding vector at block 804. For example, the document agent 110 and/or one or more of the models 116 illustrated in FIG. 1 may generate a first embedding vector based on the request. The first embedding vector may generally reflect various features of the request.

According to some examples, the logic flow 800 includes analyzing, by the model based on the first embedding vector, an embedding database comprising embedding vectors associated with a plurality of applications at block 806. For example, the analysis agent 112 and/or the models 116 may analyze, based on the first embedding vector, the embedding vector database 120, e.g., to identify similar embedding vectors in the vector database 120.

According to some examples, the logic flow 800 includes determining, by the model based on the analysis, a first application of the plurality of applications that includes features associated with the application at block 808. For example, the analysis agent 112 and/or the models 116 may determine, based on the analysis, a first application 126 of the plurality of applications 126 that includes features associated with the application. For example, the models 116 may determine that the first application 126 includes statistical analysis features.

According to some examples, the logic flow 800 includes generating, by the processor, a report comprising an indication that the first application includes the features associated with the application at block 810. For example, the orchestration agent 108 illustrated in FIG. 1 may generate a report comprising an indication that the first application includes the features associated with the application. The orchestration agent 108 may output the report as part of a graphical user interface.

According to some examples, the logic flow 800 includes transmitting, by the processor, the report to a plurality of recipients at block 812. For example, the orchestration agent 108 may transmit the report to a plurality of recipients. Doing so may inform other users of the presence of the statistical analysis software. Because some users may not be aware of all available software features, the report may assist users in identifying these features. Similarly, users may refrain from purchasing software that has redundant functionality. Embodiments are not limited in these contexts.

As used herein, an artificial intelligence system, artificial intelligence agent, artificial intelligence algorithm, artificial intelligence module, program, and the like, generally refer to computer implemented programs that are suitable to simulate intelligent behavior (e.g., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to use various analytical tools (e.g., algorithmic applications) to leverage data to make predictions or decisions. Machine learning programs may be configured to implement various algorithmic processes and learning approaches including, for example, decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG, or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, to implement the stored processes and/or optimize the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (DBSCAN), mean shift clustering, expectation maximization (EM) clustering using Gaussian mixture models (GMM), agglomerative hierarchical clustering, or the like. According to one embodiment, clustering of data may be performed using a cluster model to group data points based on certain similarities using unlabeled data. Example cluster models may include, for example, connectivity models, centroid models, distribution models, density models, group models, graph based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem. Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between -1 and 1) may be used to modify the previous coefficient, e.g., a propagated value. The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

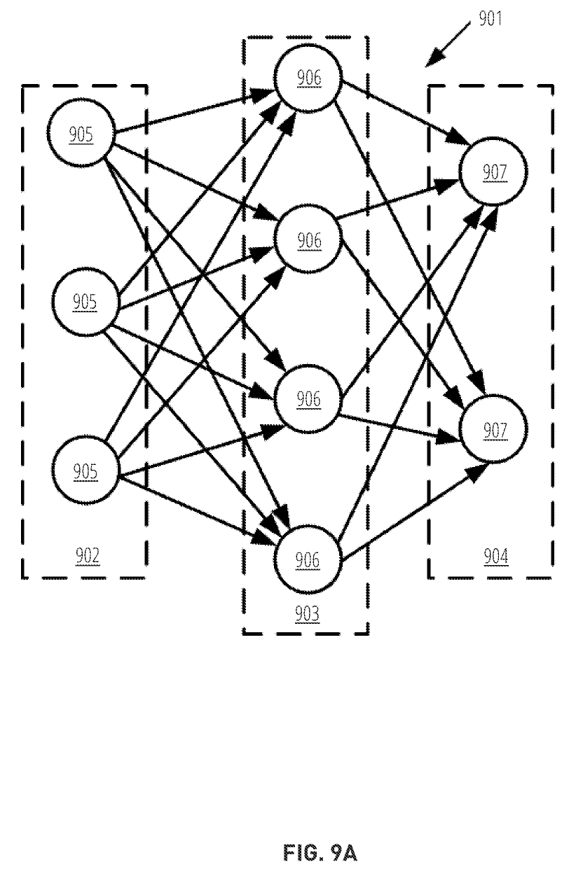

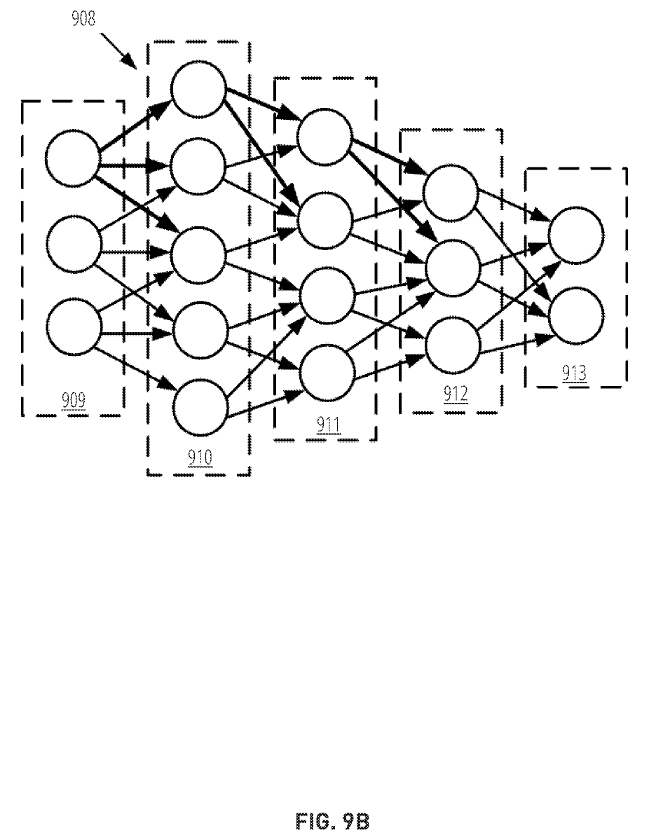

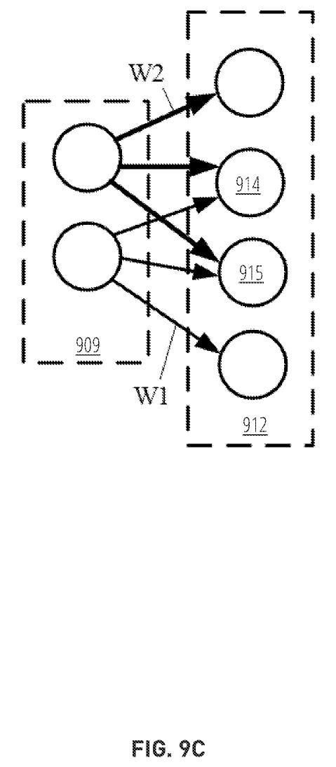

An artificial neural network (ANN), also known as a feedforward network, may be utilized, e.g., an acyclic graph with nodes arranged in layers. A feedforward network (see, e.g., feedforward network 901 referenced in FIG. 9A) may include a topography with a hidden layer 903 between an input layer 902 and an output layer 904. The input layer 902, having nodes commonly referenced in FIG. 9A as input nodes 905 for convenience, communicates input data, variables, matrices, or the like to the hidden layer 903, having nodes 906. The hidden layer 903 generates a representation and/or transformation of the input data into a form that is suitable for generating output data. Adjacent layers of the topography are connected at the edges of the nodes of the respective layers, but nodes within a layer typically are not separated by an edge. In at least one embodiment of such a feedforward network, data is communicated to the nodes 905 of the input layer, which then communicates the data to the hidden layer 903. The hidden layer 903 may be configured to determine the state of the nodes in the respective layers and assign weight coefficients or parameters of the nodes based on the edges separating each of the layers, e.g., an activation function implemented between the input data communicated from the input layer 902 and the output data communicated to the nodes 907 of the output layer 904. It should be appreciated that the form of the output from the neural network may generally depend on the type of model represented by the algorithm. Although the feedforward network 901 of FIG. 9A expressly includes a single hidden layer 903, other embodiments of feedforward networks within the scope of the descriptions can include any number of hidden layers. The hidden layers are intermediate the input and output layers and are generally where all or most of the computation is done. In some embodiments, the orchestration agent 108, document agent 110, analysis agent 112, alert generation agent 114, and/or the models 116 may include one or more of the feedforward networks 901.

An additional or alternative type of neural network suitable for use in the machine learning program and/or module is a Convolutional Neural Network (CNN). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program. A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An exemplary convolutional neural network CNN is depicted and referenced as 908 in FIG. 9B. In some embodiments, the orchestration agent 108, document agent 110, analysis agent 112, alert generation agent 114, and/or the models 116 may include one or more of the convolutional neural networks 908. As in the feedforward network 901 of FIG. 9A, the illustrated example of FIG. 9B has an input layer 909 and an output layer 913. However where a single hidden layer 903 is represented in FIG. 9A, multiple consecutive hidden layers 910, 911, and 912 are represented in FIG. 9B. The edge neurons represented by white-filled arrows highlight that hidden layer nodes can be connected locally, such that not all nodes of succeeding layers are connected by neurons.

FIG. 9C, representing a portion of the convolutional neural network 908 of FIG. 9B, specifically portions of the input layer 909 and the first hidden layer 910, illustrates that connections can be weighted. In the illustrated example, labels W1 and W2 refer to respective assigned weights for the referenced connections. Two hidden nodes 914 and 915 share the same set of weights W1 and W2 when connecting to two local patches.

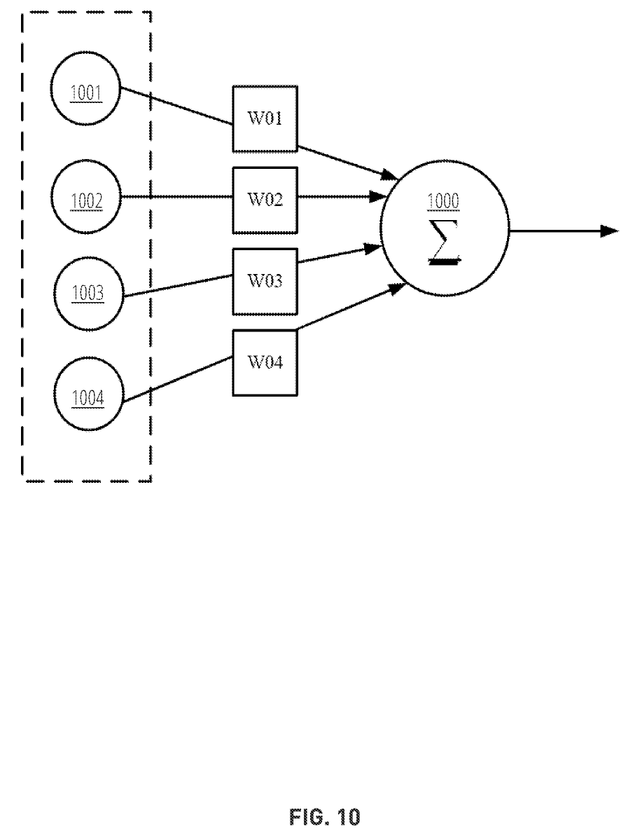

Weight defines the impact a node in any given layer has on computations by a connected node in the next layer. FIG. 10 represents a particular node 1000 in a hidden layer. The node 1000 is connected to several nodes in the previous layer representing inputs to the node 1000. The input nodes 1001, 1002, 1003 and 1004 are each assigned a respective weight W01, W02, W03, and W04 in the computation at the node 1000, which in this example is a weighted sum.

An additional or alternative type of feedforward neural network suitable for use in the machine learning program and/or module is a Recurrent Neural Network (RNN). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current computation of the parameter, e.g., at least a portion of the output data from the RNN may be used as feedback/input in computing subsequent output data. In some embodiments, the machine learning module may include an RNN configured for language processing, e.g., an RNN configured to perform statistical language modeling to predict the next word in a string based on the previous words. The RNN(s) of the machine learning program may include a feedback system suitable to provide the connection(s) between subsequent and previous layers of the network.

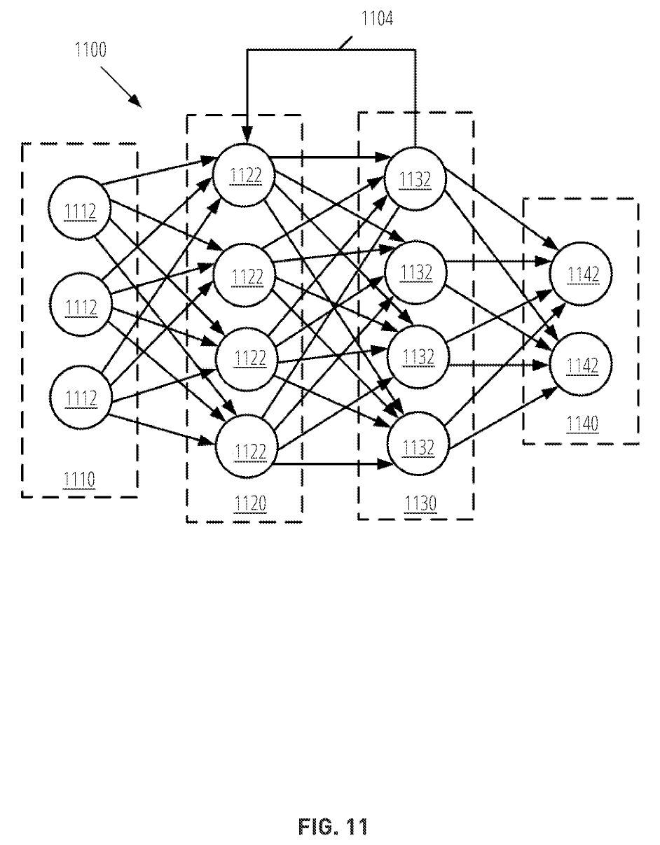

An example for a Recurrent Neural Network (RNN) is referenced as 1100 in FIG. 11. In some embodiments, the orchestration agent 108, document agent 110, analysis agent 112, alert generation agent 114, and/or the models 116 may include one or more of the recurrent neural networks 1100. As in the feedforward network 901 of FIG. 9A, the illustrated example of FIG. 11 has an input layer 1110 (with nodes 1112) and an output layer 1140 (with nodes 1142). However, where a single hidden layer 903 is represented in FIG. 9A, multiple consecutive hidden layers 1120 and 1130 are represented in FIG. 11 (with nodes 1122 and nodes 1132, respectively). As shown, the RNN 1100 includes a feedback connector 1104 configured to communicate parameter data from at least one node 1132 from the second hidden layer 1130 to at least one node 1122 of the first hidden layer 1120. It should be appreciated that two or more and up to all of the nodes of a subsequent layer may provide or communicate a parameter or other data to a previous layer of the RNN 1100. Moreover and in some embodiments, the RNN 1100 may include multiple feedback connectors 1104 (e.g., connectors 1104 suitable to communicatively couple pairs of nodes and/or feedback connectors 1104 configured to provide communication between three or more nodes). Additionally or alternatively, the feedback connector 1104 may communicatively couple two or more nodes having at least one hidden layer between them, e.g., nodes of nonsequential layers of the RNN 1100.

In an additional or alternative embodiment, the machine-learning program may include one or more support vector machines. A support vector machine may be configured to determine a category to which input data belongs. For example, the machine-learning program may be configured to define a margin using a combination of two or more of the input variables and/or data points as support vectors to maximize the determined margin. Such a margin may generally correspond to a distance between the closest vectors that are classified differently. The machine-learning program may be configured to utilize a plurality of support vector machines to perform a single classification. For example, the machine-learning program may determine the category to which input data belongs using a first support vector determined from first and second data points/variables, and the machine-learning program may independently categorize the input data using a second support vector determined from third and fourth data points/variables. The support vector machine(s) may be trained similarly to the training of neural networks, e.g., by providing a known input vector (including values for the input variables) and a known output classification. The support vector machine is trained by selecting the support vectors and/or a portion of the input vectors that maximize the determined margin.

As depicted, and in some embodiments, the machine-learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers). Generally, the neural network(s) of the machine-learning program may include a relatively large number of layers, e.g., three or more layers, and may be referred to as deep neural networks. For example, the node of each hidden layer of a neural network may be associated with an activation function utilized by the machine-learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input/output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

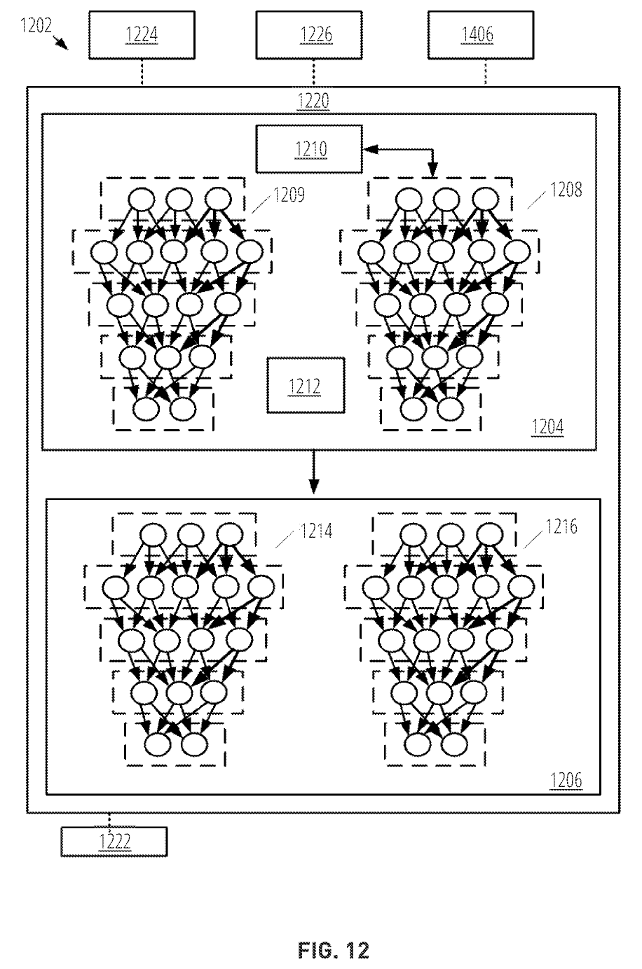

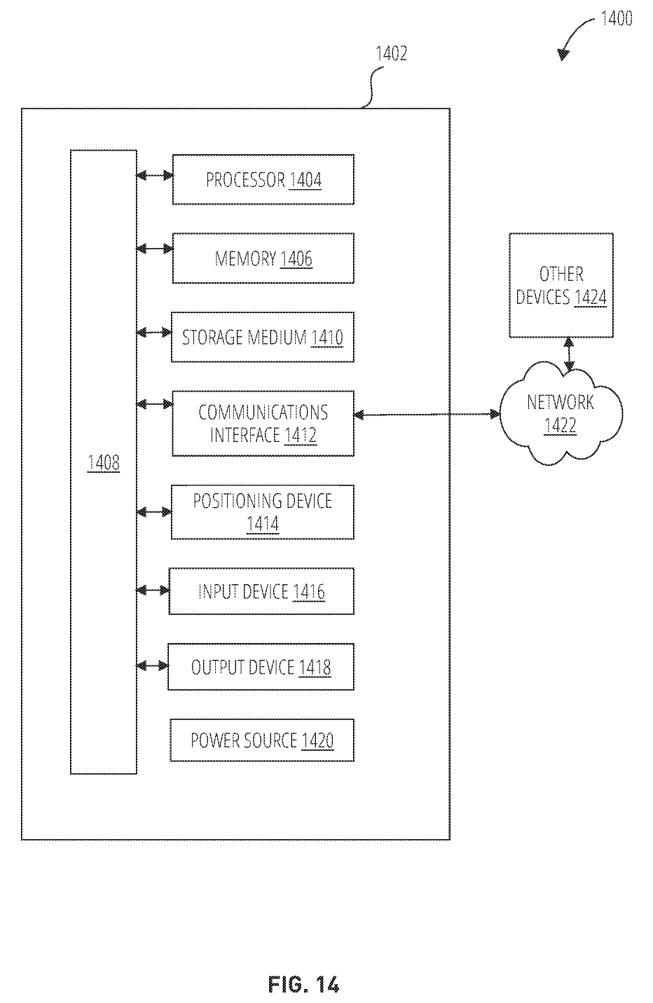

Referring now to FIG. 12 and some embodiments, an artificial intelligence (AI) program 1202 may include a front-end algorithm 1204 and a back-end algorithm 1206. The artificial intelligence program 1202 may be implemented on an AI processor 1220, such as the processor 1404 of computer 1402 of FIG. 14, and/or a dedicated processing device (e.g., computing devices 102 and/or user devices 104). The instructions associated with the front-end algorithm 1204 and the back-end algorithm 1206 may be stored in an associated memory device and/or storage device of the system (e.g., memory 1224 and/or storage 1226 in FIG. 12), etc.) communicatively coupled to the AI processor 1220, as shown. Additionally or alternatively, one or more memory devices and/or storage devices (e.g., storage medium 1410 and/or memory 1406 of FIG. 14, etc.) may be used for processing use and/or including one or more instructions necessary for operation of the AI program 1202. In some embodiments, the AI program 1202 may include a deep neural network (e.g., a front-end algorithm 1204 configured to perform pre-processing, such as feature recognition, and a back-end algorithm 1206 configured to perform an operation on the data set communicated directly or indirectly to the back-end algorithm 1206). For instance, the front-end algorithm 1204 can include at least one CNN 1208 communicatively coupled to send output data to the back-end algorithm 1206. In some embodiments, the orchestration agent 108, document agent 110, analysis agent 112, alert generation agent 114, and/or the models 116 include one or more of the AI artificial intelligence programs 1202.

Additionally or alternatively, the front-end algorithm 1204 can include one or more AI algorithms 1210, 1212 (e.g., statistical models or machine learning programs such as decision tree learning, associate rule learning, recurrent artificial neural networks, support vector machines, and the like). In various embodiments, the front-end algorithm 1204 may be configured to include built in training and inference logic or suitable software to train the neural network prior to use (e.g., machine learning logic including, but not limited to, image recognition, mapping and localization, autonomous navigation, speech synthesis, document imaging, or language translation such as natural language processing). For example, a CNN 1208 and/or AI algorithm 1210 may be used for image recognition, input categorization, and/or support vector training. In some embodiments and within the front-end algorithm 1204, an output from an AI algorithm 1210 may be communicated to a CNN 1208 or 1209, which processes the data before communicating an output from the CNN 1208, 1209 and/or the front-end algorithm 1204 to the back-end algorithm 1206. In various embodiments, the back-end algorithm 1206 may be configured to implement input and/or model classification, speech recognition, translation, and the like. For instance, the back-end algorithm 1206 may include one or more CNNs (e.g., CNN 1214) or dense networks (e.g., dense networks 1216), as described herein.

For instance, and in some embodiments of the AI program 1202, the program may be configured to perform unsupervised learning, in which the machine learning program performs the training process using unlabeled data, e.g., without known output data with which to compare. During such unsupervised learning, the neural network may be configured to generate groupings of the input data and/or determine how individual input data points are related to the complete input data set (e.g., via the front-end algorithm 1204). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 1202 may be trained using a semi-supervised learning process in which some but not all of the output data is known, e.g., a mix of labeled and unlabeled data having the same distribution.

In some embodiments, the AI program 1202 may be accelerated via a machine learning framework 1222 (e.g., hardware). The machine learning framework may include an index of operations, subroutines, and the like (primitives) typically implemented by AI and/or machine learning algorithms. Thus, the AI program 1202 may be configured to utilize the primitives of the framework 1222 to perform some or all of the computations required by the AI program 1202. Primitives suitable for inclusion in the machine learning framework 1222 include operations associated with training a convolutional neural network (e.g., pools), tensor convolutions, activation functions, algebraic subroutines and programs (e.g., matrix operations, vector operations), numerical method subroutines and programs, and the like.

It should be appreciated that the machine-learning program may include variations, adaptations, and alternatives suitable to perform the operations necessary for the system, and the present disclosure is equally applicable to such suitably configured machine learning and/or artificial intelligence programs, modules, etc. For instance, the machine-learning program may include one or more long short-term memory (LSTM) RNNs, convolutional deep belief networks, deep belief networks DBNs, and the like. DBNs, for instance, may be utilized to pre-train the weighted characteristics and/or parameters using an unsupervised learning process. Further, the machine-learning module may include one or more other machine learning tools (e.g., Logistic Regression (LR), Naive-Bayes, Random Forest (RF), matrix factorization, and support vector machines) in addition to, or as an alternative to, one or more neural networks, as described herein.

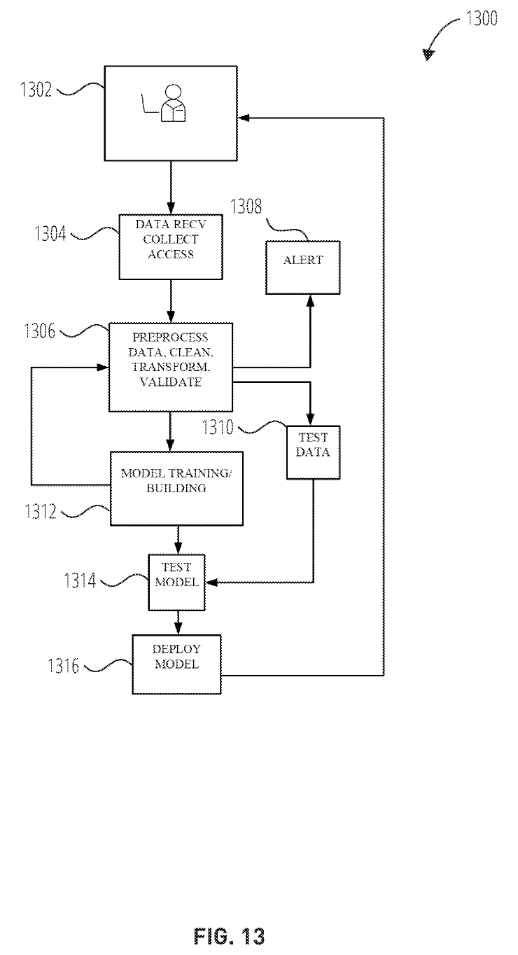

FIG. 13 is a flow chart representing a logic flow 1300, according to at least one embodiment, of model development and deployment by machine learning. The logic flow 1300 represents at least one example of a machine learning workflow in which operations are implemented in a machine-learning project. For example, the logic flow 1300 may be used as part of a project for the system 100, including but not limited to the orchestration agent 108, document agent 110, analysis agent 112, alert generation agent 114, and/or the models 116.

In block 1302, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, block 1302 can represent a starting point. However, with regard to continuing or improving an ongoing machine learning workflow, block 1302 can represent an opportunity for further user input or oversight via a feedback loop. Such feedback may flow through a user, or in various embodiments, the method automatically provides feedback, retrains and redeploys the retrained model.

In block 1304, data is received, collected, accessed, or otherwise acquired and entered as can be termed data ingestion. In block 1306, the data ingested in block 1304 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing block 1306 is updated with newly ingested data, an updated model will be generated. Block 1306 can include data validation, which focuses on confirming that the statistics of the ingested data are as expected, such as that data values are within expected numerical ranges, that data sets are within any expected or required categories, and that data comply with any needed distributions such as within those categories. Block 1306 can proceed to block 1308 to automatically alert the initiating user, other human or virtual agents, and/or other systems, if any anomalies are detected in the data, thereby pausing or terminating the process flow until corrective action is taken.

In block 1310, training test data such as a target variable value is inserted into an iterative training and testing loop. In block 1312, model training, a core step of the machine learning workflow, is implemented. A model architecture is trained in the iterative training and testing loop. For example, features in the training test data are used to train the model based on weights and iterative computations in which the target variable may be incorrectly predicted in an early iteration as determined by comparison in block 1314, where the model is tested. Subsequent iterations of the model training, in block 1312, may be conducted with updated weights in the computations.

During each iteration of the training and testing loop, the accuracy of the model may be evaluated. In one embodiment, the re-evaluation of the model can include comparing an output of the model with an actual target result or variable to determine the accuracy of the prediction. If the model is not satisfying a minimum threshold level of accuracy (e.g., the model is underfitted), the system may automatically determine that the threshold level of accuracy is not satisfied and may adjust the weights for a subsequent iteration of the training and testing loop. The weights may be iteratively adjusted during each iteration of the training and testing loop based on the comparison to the threshold level of accuracy. However, there is a balance for training the model to avoid overfitting when the model would not perform well on predictions of new data. Rather, the model is automatically trained to be well-fitted such that it satisfies a threshold level of accuracy without learning the noise in the data to the extent that the model would not apply to new data by preventing additional iterations of the training and testing once a maximum accuracy threshold value has been obtained. Thus, with each iteration of the training and testing loop, the accuracy of the model is improved and the iterative training and testing of the model provides an improvement to the performance of a computer and computing technology because the system may automatically determine how many iterations to perform so that the model is well-fitted by surpassing the minimum threshold level of accuracy while automatically stopping the iterative training and testing of the model before the maximum accuracy threshold is obtained. In some embodiments, the training and testing loop utilizes a backpropagation algorithm and a gradient descent algorithm. Gradient descent is an optimization algorithm used to minimize differentiable real-valued multivariate functions. Gradient descent is an optimization algorithm used to minimize differentiable real-valued multivariate functions. The gradient descent algorithm may be used to iteratively adjust model parameters using computed derivatives to minimize a loss function. Backpropagation may be used to compute the gradient of the error function with respect to the neural network’s weights.

When compliance and/or success in the model testing in block 1314 is achieved, process flow proceeds to block 1316, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples.

As discussed above, oversight of a deployed machine learning model may be automatically performed via a feedback loop whereby the method assesses performance of the deployed model (see block 1316) and the feedback loop automatically provides feedback for further training of the machine learning model to improve its performance, and upon completion of the other method blocks such as block 1312, the machine learning model that has been automatically retrained based on the feedback loop is then redeployed (block 1314). In some embodiments, the system is continually receiving training data as new predictions are made and more data is collected. The continuous training data may be discretized to generate input data to retrain the model. Discretization methods can convert continuous data to discrete data by binning, clustering, and numerical discretization. The model may monitor incoming data sets to make predictions. When predictions are made the system analyzes the predictions to determine whether the model needs to be retrained.

In some embodiments, the model may detect anomalies in the predictions. Anomaly detection can provide a benefit by identifying instances of the prediction that deviate from expected data or a general pattern. A difficulty in anomaly detection is that the system must define the boundary between ordinary data and anomalous data to accurately classify the data as ordinary or anomalous. The line between ordinary and anomalous may be difficult to determine with cases approaching a boundary and based on the specific application. For example, small variations may trigger an identification of an anomaly in the data while relatively larger deviations may be considered normal in less sensitive applications. The disclosed systems and methods may provide solutions for detecting anomalies to more accurately and quickly determine whether a model needs to be retrained. If data would be inapplicable or would corrupt the model by reducing the quality of the input data or training process (e.g., due to missing values, outliers, inconsistent formatting, incorrect labels, noisy data, etc.) that data may be automatically dropped and the source of that data may be blocked from providing data that would be used to train the model. This reflects an improvement in the process of training and deploying a model that is accurate and specific to the type of prediction sought. In particular, this provides an improvement in the field of model training, which provides a practical application.

In other applications, the anomaly detections processes described herein may be used to provide enhanced security to the overall computing system by detecting malicious attacks on network security. For example, the system may take proactive measures to remediate danger by detecting the source address associated with potentially malicious packets and dropping potentially malicious packets. This provides an improvement in network security by dropping potentially malicious packets and blocking future traffic from the source address of the potentially malicious source address.

The systems and methods disclosed herein may also be used to analyze text to form the predictions. In particular, the systems and methods described herein include a combination of elements that are utilized in a specific manner for automatically performing automated processes based on technological efficiency, which provides a specific improvement over prior art systems resulting in improved computer processing for faster automated processing functions. For example, the systems and method may apply robotic process automation for digital transformation of the data based on specific criteria to interpret text and unstructured data using text processing software techniques. The interpretation of the text may be implemented using the models described herein including unsupervised learning techniques or supervised learning techniques. The processor may track how much memory and/or processing time has been allocated to perform a function and the system may be trained to automatically detect and identify processes eligible for increased efficiencies based on existing inefficiencies in the process.

For example, the machine learning models may use unsupervised learning to identify and characterize hidden structures of unstructured and unlabeled content data, or supervised techniques that operate on labeled content data and include instructions informing the system which outputs are related to specific input values. In such instances, software processing can rely on iterative training techniques and training data to configure neural networks with an understanding of individual words, phrases, subjects, sentiments, and parts of speech.

Supervised learning software systems are trained using content data that is labeled or “tagged.” During training, the supervised software systems learn the best mapping function between a known data input and expected known output (e.g., labeled or tagged content data). Supervised natural language processing software then uses the best approximating mapping learned during training to analyze unforeseen input data (never seen before) to accurately predict the corresponding output. Supervised learning software systems often require extensive and iterative optimization cycles to adjust the input-output mapping until they converge to an expected and well-accepted level of performance, such as an acceptable threshold error rate between a computed probability and a desired threshold probability.

The software systems are supervised because the way of learning from training data mimics the same process of a teacher supervising the end-to-end learning process. Supervised learning software systems are typically capable of achieving excellent levels of performance, but this excellent level of performance requires labeled data to be available. Developing, scaling, deploying, and maintaining accurate supervised learning software systems can take significant time, resources, and technical expertise from a team of skilled data scientists. Moreover, precision of the systems is dependent on the availability of labeled content data for training that is comparable to the corpus of content data that the system will process in a production environment.

Supervised learning software systems implement techniques that include, without limitation, Latent Semantic Analysis (“LSA”), Probabilistic Latent Semantic Analysis (“PLSA”), Latent Dirichlet Allocation (“LDA”), and more recent Bidirectional Encoder Representations from Transformers (“BERT”). Latent Semantic Analysis software processing techniques process a corporate of content data files to ascertain statistical co-occurrences of words that appear together, which then give insights into the subjects of those words and documents.

Unsupervised learning software systems can perform training operations on unlabeled data and less requirement for time and expertise from trained data scientists. Unsupervised learning software systems can be designed with integrated intelligence and automation to automatically discover information, structure, and patterns from content data. Unsupervised learning software systems can be implemented with clustering software techniques that include, without limitation, K-means clustering, Mean-Shift clustering, Density-based clustering, Spectral clustering, Principal Component Analysis, and Neural Topic Modeling (“NTM”).

Clustering software techniques can automatically group semantically similar words together to accelerate the derivation and verification of an underneath common intent—e.g., ascertain or derive a new classification or subject, and not just classification into an existing subject or classification. Unsupervised learning software systems are also used for association rules mining to discover relationships between features from content data.

The content driver software service utilizes one or more supervised or unsupervised software processing techniques to perform a subject classification analysis to generate subject data. Suitable software processing techniques can include, without limitation, Latent Semantic Analysis, Probabilistic Latent Semantic Analysis, Latent Dirichlet Allocation. Latent Semantic Analysis software processing techniques generally process a corpus of alphanumeric text files, or documents, to ascertain statistical co-occurrences of words that appear together, which then give insights into the subjects of those words and documents. The content driver software service can utilize software processing techniques that include Non-Matrix Factorization, Correlated Topic Model (“CTM”), and K-Means or other types of clustering.

Neural networks may be trained using training set content data that comprise sample tokens, phrases, sentences, paragraphs, or documents for which desired subjects, content sources, interrogatories, or sentiment values are known. A labeling analysis may be performed on the training set content data to annotate the data with known subject labels, interrogatory labels, content source labels, or sentiment labels, thereby generating annotated training set content data. For example, a person can utilize a labeling software application to review training set content data to identify and tag or “annotate” various parts of speech, subjects, interrogatories, content sources, and sentiments.

The training set content data may then be fed to the content driver software service neural networks to identify subjects, content sources, or sentiments and the corresponding probabilities. For example, the analysis might identify that particular text represents a question with a 35% probability. If the annotations indicate the text is, in fact, a question, an error rate can be taken to be 65% or the difference between the computed probability and the known certainty. Then parameters to the neural network are adjusted (e.g., constants and formulas that implement the nodes and connections between node), to increase the probability from 35% to ensure the neural network produces more accurate results, thereby reducing the error rate. The process is run iteratively on different sets of training set content data to continue to increase the accuracy of the neural network.

The content data is first pre-processes using a reduction analysis to create reduced content data. The reduction analysis first performs a qualification operation that removes unqualified content data that does not meaningfully contribute to the subject classification analysis. The qualification operation removes certain content data according to criteria defined by a provider. For instance, the qualification analysis can determine whether content data files are “empty” and contain no recorded linguistic interaction between a provider agent and a user and designate such empty files as not suitable for use in a subject classification analysis. As another example, the qualification analysis can designate files below a certain size or having a shared experience duration below a given threshold (e.g., less than one minute) as also being unsuitable for use in the subject classification analysis.

The reduction analysis can also perform a contradiction operation to remove contradictions and punctuations from the content data. Contradictions and punctuation include removing or replacing abbreviated words or phrases that can cause inaccuracies in a subject classification analysis. Examples include removing or replacing the abbreviations “min” for minute, “u” for you, and “wanna” for “want to,” as well as apparent misspellings, such as “mssed” for the word missed. In some embodiments, the contradictions can be replaced according to a standard library of known abbreviations, such as replacing the acronym “brb” with the phrase “be right back.” The contradiction operation can also remove or replace contractions, such as replacing “we’re” with “we are.”

The reduction analysis can also streamline the content data by performing one or more of the following operations, including: (i) tokenization to transform the content data into a collection of words or key phrases having punctuation and capitalization removed; (ii) stop word removal where short, common words or phrases such as “the” or “is” are removed; (iii) lemmatization where words are transformed into a base form, like changing third person words to first person and changing past tense words to present tense; (iv) stemming to reduce words to a root form, such as changing plural to singular; and (v) hyponymy and hypernym replacement where certain words are replaced with words having a similar meaning so as to reduce the variation of words within the content data.

Following a reduction analysis, the reduced content data is vectorized to map the alphanumeric text into a vector form. One approach to vectorizing content data includes applying “bag-of-words” modeling. The bag-of-words approach counts the number of times a particular word appears in content data to convert the words into a numerical value. The bag-of-words model can include parameters, such as setting a threshold on the number of times a word must appear to be included in the vectors.

Techniques to encode the context communication elements (e.g., such as words, speech patterns, tone, timbre, cadence, etc.) may, in part, determine how often communication elements appear together. Determining the adjacent pairing of communication elements can be achieved by creating a co-occurrence matrix with the value of each member of the matrix counting how frequently one communication element coincides with another, either just before or just after it. That is, the words or communication elements form the row and column labels of a matrix, and a numeric value appears in matrix elements that correspond to a row and column label for communication elements that appear adjacent in the content data.

As an alternative to counting communication elements (e.g., words) in a corpus of content data and turning it into a co-occurrence matrix, another software processing technique may be used where a communication element in the content data corpus predicts the next communication element. Looking through a corpus, counts may be generated for adjacent communication elements, and the counts are converted from frequencies into probabilities (e.g., using n-gram predictions with Kneser-Ney smoothing) using a simple neural network. Suitable neural network architectures for such purpose include a skip-gram architecture. The neural network may be trained by feeding through a large corpus of content data, and embedded middle layers in the neural network are adjusted to best predict the next word.

The predictive processing creates weight matrices that densely carry contextual, and hence semantic, information from the selected corpus of content data. Pre-trained, contextualized content data embedding can have high dimensionality. To reduce the dimensionality, a uniform manifold approximation and projection algorithm (“UMAP”) can be applied to reduce dimensionality while maintaining essential information.

Prior to conducting a subject analysis to ascertain subject identifiers in the content data (e.g., topics or subjects addressed in the content data) or interaction driver identifiers in the content data (e.g., reasons why the customer initiated the interaction with the provider, such as the reason underlying a support request), the system can perform a concentration analysis on the content data. The concentration analysis concentrates, or increases the density of, the content data by identifying and retaining communication elements that have significant weight in the subject analysis and discarding or ignoring communication elements that have relativity little weight.

In one embodiment, the concentration analysis includes executing a term frequency–inverse document frequency (“tf-idf”) software processing technique to determine the frequency or corresponding weight quantifier for communication elements with the content data. The weight quantifiers are compared against a pre-determined weight threshold to generate concentrated content data that is made up of communication elements having weight quantifiers above the weight threshold.

The concentrated content data is processed using a subject classification analysis to determine subject identifiers (e.g., topics) addressed within the content data. The subject classification analysis can specifically identify one or more interaction driver identifiers that are the reason why a user initiated a shared experience or support service request. An interaction driver identifier can be determined by, for example, first determining the subject identifiers having the highest weight quantifiers (e.g., frequencies or probabilities) and comparing such subject identifiers against a database of known interaction driver identifiers.

In one embodiment, the subject classification analysis is performed on the content data using a Latent Dirichlet Allocation analysis to identify subject data that includes one or more subject identifiers (e.g., topics addressed in the underlying content data). Performing the LDA analysis on the reduced content data may include transforming the content data into an array of text data representing key words or phrases that represent a subject (e.g., a bag-of-words array) and determining the one or more subjects through analysis of the array. Each cell in the array can represent the probability that given text data relates to a subject. A subject is then represented by a specified number of words or phrases having the highest probabilities (e.g., the words with the five highest probabilities), or the subject is represented by text data having probabilities above a predetermined subject probability threshold.

Clustering software processing techniques include K-means clustering, which is an unsupervised processing technique that does not utilized labeled content data. Clusters are defined by “K” number of centroids where each centroid is a point that represents the center of a cluster. The K-means processing technique run in an iterative fashion where each centroid is initially placed randomly in the vector space of the dataset, and the centroid moves to the center of the points that is closest to the centroid. In each new iteration, the distance between each centroid and the points are recomputed, and the centroid moves again to the center of the closest points. The processing completes when the position or the groups no longer change or when the distance in which the centroids change does not surpass a pre-defined threshold.

The clustering analysis yields a group of words or communication elements associated with each cluster, which can be referred to as subject vectors. Subjects may each include one or more subject vectors where each subject vector includes one or more identified communication elements (e.g., keywords, phrases, symbols, etc.) within the content data as well as a frequency of the one or more communication elements within the content data. The content driver software service can be configured to perform an additional concentration analysis following the clustering analysis that selects a pre-defined number of communication elements from each cluster to generate a descriptor set, such as the five or ten words having the highest weights in terms of frequency of appearance (or in terms of the probability that the words or phrases represent the true subject when neural networking architecture is used). In one embodiment, the descriptor sets were analyzed to determine if the reasons driving a customer support request were identified by the descriptor set subject identifiers.

The software model may be evaluated according to three categories, including a “good match” where the support request reason(s) are identified by the top words in the subject vector (e.g., the words with the highest weight or frequency), a “moderate” match where the support request reason(s) are identified by the second tier of words in the subject vector (e.g., words six to ten), and a “poor” match where, for instance, the top words in a subject vector do not match or identify the reasons the support request was initiated.

Alternatively, instead of selecting a pre-determined number of communication elements, post-clustering concentration analysis can analyze the subject vectors to identify communication elements that are included in several subject vectors having a weight quantifier (e.g., a frequency) below a specified weight threshold level that are then removed from the subject vectors. In this manner, the subject vectors are refined to exclude content data less likely to be related to a given subject. To reduce an effect of spam, the subject vectors may be analyzed, such that if one subject vector is determined to include communication elements that are rarely used in other subject vectors, then the communication elements are marked as having a poor subject correlation and is removed from the subject vector.

In another embodiment, the concentration analysis is performed on unclassified content data by mapping the communication elements within the content data to integer values. The content data is thus turned into a bag-of-words that includes integer values and the number of times the integers occur in content data. The bag-of-words is turned into a unit vector, where all the occurrences are normalized to the overall length. The unit vector may be compared to other subject vectors produced from an analysis of content data by taking the dot product of the two-unit vectors. All the dot products for all vectors in a given subject are added together to provide a weighting quantifier or score for the given subject identifier, which is taken as subject weighting data. A similar analysis can be performed on vectors created through other processing, such as K-means clustering or techniques that generate vectors where each word in the vector is replaced with a probability that the word represents a subject identifier or request driver data.

To illustrate generating subject weighting data, for any given subject there may be numerous subject vectors. Assume that for most of subject vectors, the dot product will be close to zero — even if the given content data addresses the subject at issue. Since there are some subjects with numerous subject vectors, there may be numerous small dot products that are added together to provide a significant score. Put another way, the particular subject is addressed consistently throughout a document, several documents, sessions of the content data, and the recurrence of the carries significant weight.

In another embodiment, a predetermined threshold may be applied where any dot product that has a value less than the threshold is ignored and only stronger dot products above the threshold are summed for the score. In another embodiment, this threshold may be empirically verified against a training data set to provide a more accurate subject analysis.

In another example, a number of subject identifiers may be substantially different, with some subjects having orders of magnitude fewer subject vectors than do other subjects. The weight scoring might significantly favor relatively unimportant subjects that occur frequently in the content data. To address this problem, a linear scaling on the dot product scoring based on the number of subject vectors may be applied. The result provides a correction to the score so that important but less common subjects are weighed more heavily.

Once all scores are computed for all subjects, then subjects may be sorted, and the most probable subjects are returned. The resulting output provides an array of subjects and strengths. In another embodiment, hashes may be used to store the subject vectors to provide a simple lookup of text data (e.g., words and phrases) and strengths. The one or more subject vectors can be represented by hashes of words and strengths, or alternatively an ordered byte stream (e.g., an ordered byte stream of 4-byte integers, etc.) with another array of strengths (e.g., 4-byte floating-point strengths, etc.).

The content driver software service can also use term frequency–inverse document frequency software processing techniques to vectorize the content data and generating weighting data that weight words or particular subjects. The tf-idf is represented by a statistical value that increases proportionally to the number of times a word appears in the content data. This frequency is offset by the number of separate content data instances that contain the word, which adjusts for the fact that some words appear more frequently in general across multiple shared experiences or content data files. The result is a weight in favor of words or terms more likely to be important within the content data, which in turn can be used to weigh some subjects more heavily in importance than others. To illustrate with a simplified example, the tf-idf might indicate that the term “password” carries significant weight within content data. To the extent any of the subjects identified by a natural language processing analysis include the term “password,” that subject can be assigned more weight by the content driver software service.

The content data can be visualized and subject to a reduction into two-dimensional data using a UMAP to generate a cluster graph visualizing a plurality of clusters. The content driver software service feeds the two-dimensional data into a DBSCAN and identify a center of each cluster of the plurality of clusters. The process may, using the two dimensional data from the UMAP and the center of each cluster from the DBSCAN, apply a KNN to identify data points closest to the center of each cluster and shade each of the data points to graphically identify each cluster of the plurality of clusters. The processor may illustrate a graph on the display representative of the data points that are shaded following application of the KNN.

The content driver software service can also incorporate Part of Speech (“POS”) tagging software code that assigns words a part of speech depending upon the neighboring words, such as tagging words as a noun, pronoun, verb, adverb, adjective, conjunction, preposition, or other relevant parts of speech. The content driver software service can utilize the POS tagged words to help identify questions and subjects according to pre-defined rules, such as recognizing that the word “what” followed by a verb is also more likely to be a question than the word “what” followed by a preposition or pronoun (e.g., “What is this?” versus “What he wants is an answer.”).

POS tagging in conjunction with Named Entity Recognition (“NER”) software processing techniques can be used by the content driver software service to identify various content sources within the content data. NER techniques are utilized to classify a given word into a category, such as a person, product, organization, or location. Using POS and NER techniques to process the content data allow the content driver software service to identify particular words and text as a noun and as representing a person participating in the discussion (e.g., a content source).

The systems and methods disclosed herein may utilize deployed models (e.g., machine learning models, neural networks, large language models, predictive models, etc.) such as the orchestration agent 108, document agent 110, analysis agent 112, alert generation agent 114, and/or the models 116 to make predictions about the presence of features in applications. The use of specially trained models realizes a number of improvements over traditional methods of feature detection, including more accurate predictions as to whether an application includes an input feature. Further, the systems and methods disclosed herein lead to faster training times and a more accurate model.

The systems and methods disclosed herein reflect an improvement in the functioning of a computer or an improvement to other technology or a technical field by allowing for the identification of features in application portfolios.

In addition, the systems and methods utilize a particular machine or manufacture such as, for example, computing devices 102. The computing devices 102 are integral to effectuating the improvements disclosed herein. Further, the systems and methods disclosed herein utilize a combination of software and hardware that include, for example, a physical circuit, which is a machine or manufacture.

FIG. 14 illustrates an example computing system 1400 suitable for implementing various embodiments as described herein. As shown, the computing system 1400 comprises a computer 1402, which is representative of any type of physical and/or virtualized computing device. Examples of the computer 1402 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), container, or any other device with processing capabilities. In one embodiment, the computer 1402 is representative of some or all of the components of the system 100, including the computing devices 102, user devices 104, and/or application servers 124. More generally, the computing system 1400 is configured to implement all systems, methods, apparatuses, media, and embodiments disclosed herein.

As shown, the computer 1402 includes one or more processors 1404, one or more memories 1406, one or more non-transitory storage media 1410, one or more communications interfaces 1412, one or more positioning devices 1414, one or more input devices 1416, and one or more output devices 1418 communicably coupled via an interconnect 1408. A power source 1420, such as a power supply, battery, or any type of power source may provide power to the computer 1402.

The processor 1404 is representative of any type of processing circuit. For example, the processor 1404 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 1406 is representative of any computer readable medium to store data, code, or other information. The memory 1406 may include volatile memory, such as volatile Random Access Memory (RAM) including a cache area for the temporary storage of data. The memory 1406 may also include non-volatile memory, which can be embedded and/or may be removable. The non-volatile memory can additionally or alternatively include an electrically erasable programmable read-only memory (EEPROM), flash memory or the like. The storage medium 1410 is representative of any type of computer readable medium to store data, code, or other information. Examples of storage media 1410 include solid state drives, hard drives, Redundant Array of Independent Disks (RAID) drives, memory pools, universal serial bus (USB) storage devices, and the like.

The memory 1406 and storage medium 1410 can store any number and type of computer-executable instructions executed by the processor 1404 to implement the functions of the computer 1402 described herein. For example, the memory 1406 may include such applications as a web browser application and/or a mobile P2P payment system client application. These applications also typically provide a graphical user interface (GUI) on a display that allows the user to communicate with the computer 1402, and, for example a mobile banking system, and/or other devices or systems. In one embodiment, when the user decides to enroll in a mobile banking program, the user downloads or otherwise obtains the mobile banking system client application from a mobile banking system, or from a distinct application server. In other embodiments, the user interacts with a mobile banking system via a web browser application in addition to, or instead of, the mobile P2P payment system client application. Similarly, the memory 1406 and/or storage medium 1410 may be used to store data such as cached data, files for user accounts, user profiles, account balances, transaction histories, files downloaded or received from other devices, and any other data items. Further still, the memory 1406 and/or storage medium 1410 may store the orchestration agent 108, document agent 110, analysis agent 112, alert generation agent 114, and/or the models 116.

The interconnect 1408 is representative of any type of circuitry to connect the components of the computer 1402. For example, the interconnect 1408 can include or represent, a system bus, a USB interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 1404 to the memory 1406, individual electrical connections among the components, and electrical conductive traces on a motherboard common to some or all of the above-described components of the computer 1402. As discussed herein, the interconnect 1408 may operatively couple various components with one another, or in other words, electrically connects those components, either directly or indirectly – by way of intermediate component(s) - with one another.

The one or more input devices 1416 are representative of any type of input device for receiving input, such as a keypad, keyboard, touchscreen, touchpad, microphone, camera, fingerprint sensor, mouse, joystick, other pointer device, button, soft key, and the like. The one or more output devices 1418 are representative of any type of device for outputting information, such as a monitor, speaker, haptic feedback module, printer, and the like.

The computer 1402 may use the communications interface 1412 to communicate with one or more other devices 1424 via a network 1422. The communications interface 1412 allows the computer 1402 to communicate with and conduct transactions with other devices and systems, such as the other devices 1424. The communications interface 1412 may be a wired and/or a wireless interface. Communications may be conducted via various modes or protocols, of which Global System for Mobile Communications (GSM) voice calls, Short Message Service (SMS), Enhanced Messaging Service (EMS), Multimedia Messaging Service (MMS) messaging, Time Division Multiple Access (TDMA), Code Division Multiple Access (CDMA), Personal Digital Cellular (PDC), Wideband Code Division Multiple Access (WCDMA), CDMA2000, and General Packet Radio Service (GPRS), are all non-limiting and non-exclusive examples. Thus, communications can be conducted, for example, via the wireless communications interface 1412, which can be or include a radio-frequency transceiver, a Bluetooth device, Wi-Fi device, a Near-Field Communication (NFC) device, and other wireless transceivers. In addition, a positioning device 1414 such as a Global Positioning System (GPS) device may be included for navigation and location-related data exchanges, ingoing and/or outgoing. Wi-Fi networks use radio technologies such as the Institute of Electrical and Electronics Engineers (IEEE) 802.11x (a, b, g, n, ac, ax, etc.) to provide secure, reliable, fast wireless connectivity. A Wi-Fi network connects computers to each other, to the Internet, and to wired networks (which use IEEE 802.3-related media and functions). A Wi-Fi network connects computers to each other, to the Internet, and to wired networks (which use IEEE 802.3-related media and functions). Communications may also and/or alternatively be conducted via wired connections using the communications interface 1412, e.g., using USB, Ethernet, and other physically connected modes of data transfer. The network 1422 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 1402 is configured to use the communications interface 1412 as, for example, a network interface to communicate with one or more other devices on a network such as network 1422. In this regard, the computer 1402 utilizes the wireless communications interface 1412 as an antenna operatively coupled to a transmitter and a receiver (together a “transceiver”) included with the communications interface 1412. The communications interface 1412 is configured to provide signals to and receive signals from the transmitter and receiver, respectively. The signals may include signaling information in accordance with the air interface standard of the applicable cellular system of a wireless telephone network. In this regard, the computer 1402 may be configured to operate with one or more air interface standards, communication protocols, modulation types, and access types. By way of illustration, the computer 1402 may be configured to operate in accordance with any of a number of first, second, third, fourth, fifth-generation communication protocols and/or the like. For example, the as a smartphone, the computer 1402 be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The computer 1402 may also be configured to operate in accordance with non-cellular communication mechanisms, such as via a wireless local area network (WLAN) or other communication/data networks.

The communications interface 1412 may also include a payment network interface. The payment network interface may include software, such as encryption software, and hardware, such as a modem, for communicating information to and/or from one or more devices on a network. For example, the computer 1402 may be configured so that it can be used as a credit or debit card by, for example, wirelessly communicating account numbers or other authentication information to a terminal of the network. Such communication could be performed via transmission over a wireless communication protocol such as the NFC protocol.

The computer 1402 may be under the control of any suitable operating system (not pictured). Example operating systems include, but are not limited to, Linux® operating systems, UNIX®, Windows® operating systems, macOS®, iOS®, Android® and any other type of operating system.

The computer 1402 as illustrated diagrammatically represents at least one example of a possible implementation, where alternatives, additions, and modifications are possible for performing some or all of the described methods, operations, and functions. Although shown separately, in some embodiments, two or more computers 1402, systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms "a", "an" and "the" are intended to include the plural forms as well, unless the context clearly indicates otherwise. It will be further understood that the terms "comprise" (and any form of comprise, such as "comprises" and "comprising"), "have" (and any form of have, such as "has" and "having"), "include" (and any form of include, such as "includes" and "including"), and "contain" (and any form contain, such as "contains" and "containing") are open-ended linking verbs. As a result, a method or device that "comprises", "has", "includes" or "contains" one or more steps or elements possesses those one or more steps or elements, but is not limited to possessing only those one or more steps or elements. Likewise, a step of a method or an element of a device that "comprises", "has", "includes" or "contains" one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described to explain the principles of one or more aspects of the disclosure and the practical application, and to enable others of ordinary skill in the art to understand one or more aspects of the disclosure for various embodiments with various modifications as are suited to the particular use contemplated.

What is claimed is:

1. A method, comprising:
receiving, by a processor, a request comprising an application;
generating, by the processor based on the request, a first embedding vector;
analyzing, by a model executing the processor based on the first embedding vector, an embedding database comprising embedding vectors associated with a plurality of applications;
determining, by the model based on the analysis, a first application of the plurality of applications that includes features associated with the application;
generating, by the processor, a report comprising an indication that the first application includes the features associated with the application; and
transmitting, by the processor, the report to a plurality of recipients.

2. The method of claim 1, wherein the analysis comprises:
computing, by the model based on the analysis, a similarity score for the first application and the application.

3. The method of claim 2, wherein the analysis comprises:
determining, by the model, that the similarity score exceeds a threshold.

4. The method of claim 1, wherein the analysis comprises:
computing, by the model, a cosine similarity of the first embedding vector and a second embedding vector, wherein the second embedding vector is associated with the first application.

5. The method of claim 4, wherein the analysis comprises:
determining, by the model, the cosine similarity exceeds a threshold.

6. The method of claim 1, wherein the analysis comprises:
computing, by the model, a Euclidean distance between the first embedding vector and a second embedding vector, wherein the second embedding vector is associated with the first application.

7. The method of claim 6, wherein the analysis comprises:
determining, by the model, the Euclidean distance exceeds a threshold.

8. The method of claim 1, wherein the embedding vectors of the embedding database are based at least in part on a plurality of documents.

9. The method of claim 8, wherein each document of the plurality of documents is associated with one or more of the plurality of applications.

10. The method of claim 9, wherein the plurality of documents comprise: (i) documentation, (ii) release notes, (iii) marketing documents, (iv) technical notes, and (v) other documents associated with the plurality of applications.

11. The method of claim 1, further comprising:
generating, by the processor, a prompt based at least in part on the request; and
providing, by the processor, the prompt to the model.

12. The method of claim 11, wherein the prompt indicates the features associated with the application.

13. The method of claim 1, further comprising:
determining, by the model, a portion of a document indicating the presence, in the first application, of the features associated with the application.

14. The method of claim 13, further comprising:
outputting, by the processor in a graphical user interface, an indication of the portion of the document.

15. The method of claim 14, further comprising:
receiving, via the graphical user interface, selection of the indication.

16. The method of claim 15, further comprising:
displaying, via the graphical user interface, at least the portion of the document.

17. The method of claim 1, wherein the report further comprises a second application of the plurality of applications that includes the features associated with the application.

18. The method of claim 1, further comprising:
generating, by the processor, a graphical user interface comprising an indication that the first application includes the application feature; and
outputting, by the processor, the graphical user interface on a display.

19. A non-transitory computer-readable storage medium, the computer-readable storage medium including instructions that when executed by a processor, cause the processor to:
receive a request comprising an application;
generate, based on the request, a first embedding vector;
analyze, by a model based on the first embedding vector, an embedding database comprising embedding vectors associated with a plurality of applications;
determine, by the model based on the analysis, a first application of the plurality of applications that includes features associated with the application;
generate a report comprising an indication that the first application includes the features associated with the application; and
transmit the report to a plurality of recipients.

20. An apparatus, comprising:
a processor; and
a memory storing instructions that, when executed by the processor, cause the processor to:
receive a request comprising an application;
generate, based on the request, a first embedding vector;
analyze, by a model based on the first embedding vector, an embedding database comprising embedding vectors associated with a plurality of applications;
determine, by the model based on the analysis, a first application of the plurality of applications that includes features associated with the application;
generate a report comprising an indication that the first application includes the features associated with the application; and
transmit the report to a plurality of recipients.
